(19) United States
(12) Patent Application Publication
(10) Pub. No.: US 2019/0324341 A1
(43) Pub. Date: Oct. 24, 2019

(54) PLASTIC COATINGS FOR IMPROVED SOLVENT RESISTANCE

(71) Applicant: Gentex Corporation, Zeeland, MI (US)

(72) Inventors: William L. Tonar, Holland, MI (US); Garret C. DeNolf, Grand Rapids, MI (US); Gary J. Dozeman, Zeeland, MI (US); George A. Neuman, Holland, MI (US); Mario F. Saenger Nayver, Zeeland, MI (US); John S. Anderson, Holland, MI (US); Jeffrey A. Forgette, Hudsonville, MI (US); Sheng Liu, Holland, MI (US); Yuping Lin, Tucker, GA (US)

(21) Appl. No.: 16/388,204

(22) Filed: Apr. 18, 2019

Related U.S. Application Data
(60) Provisional application No. 62/660,018, filed on Apr. 19, 2018.
(60) Provisional application No. 62/769,693, filed on Nov. 20, 2018.

(51) Int. Cl. G02F 1/1516; G02F 1/1523; G02F 1/153; B32B 15/085; B32B 15/09; B32B 15/082

(52) U.S. Cl. CPC G02F 1/15165; G02F 1/1523; G02F 1/1533; G02F 2001/15145; B32B 15/09; B32B 15/082; B32B 15/085

(57) ABSTRACT

An electro-optic element includes a first substantially transparent polymer substrate defining first and second surfaces. The second surface includes a first electrically conductive layer. A first polymer multi-layer film is disposed between the first substrate and the first conductive layer. The first polymer multi-layer film includes a first polymer layer, an inorganic layer, and a second polymer layer. A second substantially transparent substrate defines a third surface and a fourth surface. The third surface includes a second electrically conductive layer. An electrochromic medium is disposed in a cavity defined between the first and second substrates and includes a cathodic material, an anodic material, and at least one solvent.

### CROSS-REFERENCE TO RELATED APPLICATIONS

This application claims priority to and the benefit under 35 U.S.C. § 119(e) of U.S. Provisional Patent Application No. 62/769,693, filed on Nov. 20, 2018, entitled “Plastic Coatings for Improved Solvent Resistance,” and U.S. Provisional Patent Application No. 62/660,018, filed on Apr. 19, 2018, entitled “Plastic Coatings for Improved Solvent Resistance,” the contents of which are both incorporated herein by reference in their entirety.

### FIELD

The present technology is generally related to electrochromic devices, and more particularly, relates to electrochromic devices having at least one plastic substrate.

### BACKGROUND

The use of plastic substrates in electrochromic (EC) devices can lead to challenges such as the susceptibility of the transparent conductor coated plastic to degrade in the presence of electrochromic mediums at various temperatures and chemistries. The combination of solvents used in the electrochromic chemistry combined with elevated temperatures during operation can degrade the conductive electrode, typically an ITO layer, deposited on the plastic substrate, which may cause defects and the ultimate failure of the device. Accordingly, new designs and methods of fabricating plastic substrates having a conductive layer are needed to improve the longevity and efficiency of electrochromic devices.

### SUMMARY OF THE DISCLOSURE

According to an aspect of the present disclosure, an electro-optic element includes a first substantially transparent polymer substrate defining first and second surfaces. The second surface includes a first electrically conductive layer. A first polymer multi-layer film is disposed between the first substrate and the first conductive layer. The polymer multi-layer film includes a first polymer layer, an inorganic layer, and a second polymer layer. A second substantially transparent substrate defines a third surface and a fourth surface. The third surface includes a second electrically conductive layer. An electrochromic medium is disposed in a cavity defined between the first and second substrates and includes an electrochromic medium including a cathodic material, an anodic material, and at least one solvent.

According to an aspect of the present disclosure, an electro-optic element includes a first substantially transparent polymer substrate defining first and second surfaces. The second surface includes a first electrically conductive layer. A first hardcoat layer is disposed between the first substrate and the first conductive layer. A second substantially transparent polymer substrate defines third and fourth surfaces. The third surface comprises a second electrically conductive layer. A second hardcoat layer is disposed between the second substrate and the second conductive layer. An electrochromic medium is disposed in a cavity defined between the first and second substrates and includes a cathodic material, an anodic material, and at least one solvent. The first and second electrically conductive layers are characterized by a change in sheet resistance of less than 20% after exposure to the electrochromic medium at an electrochromic medium temperature of 45° C. for 1000 hours.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a cross-sectional view of an electro-optic element according to some aspects of the present disclosure;

FIG. 2 is a cross-sectional view of a substrate stack according to some aspects of the present disclosure;

FIG. 3A is a cross-sectional view of a substrate stack having two hardcoat layers according to some aspects of the present disclosure;

FIG. 3B is a cross-sectional view of a substrate stack having two hardcoat layers according to some aspects of the present disclosure;

FIG. 3C is a cross-sectional view of a substrate stack having two hardcoat layers according to some aspects of the present disclosure;

FIG. 3D is a cross-sectional view of a substrate stack having two hardcoat layers according to some aspects of the present disclosure;

FIG. 4A is a cross-sectional view of a substrate stack having two hardcoat layers and an inorganic layer according to some aspects of the present disclosure;

FIG. 4B is a cross-sectional view of a substrate stack having two hardcoat layers and an inorganic layer according to some aspects of the present disclosure;

FIG. 4C is a cross-sectional view of a substrate stack having two hardcoat layers and an inorganic layer according to some aspects of the present disclosure;

FIG. 4D is a cross-sectional view of a substrate stack having two hardcoat layers and an inorganic layer according to some aspects of the present disclosure;

FIG. 5A is a cross-sectional view of a substrate stack having two hardcoat layers and a metal layer according to some aspects of the present disclosure;

FIG. 5B is a cross-sectional view of a substrate stack having two hardcoat layers and a metal layer according to some aspects of the present disclosure;

FIG. 5C is a cross-sectional view of a substrate stack having two hardcoat layers and a metal layer according to some aspects of the present disclosure;

FIG. 5D is a cross-sectional view of a substrate stack having two hardcoat layers and a metal layer according to some aspects of the present disclosure;

FIG. 6 is a graph of the effect of testing temperature on sheet resistance stability according to some aspects of the present disclosure;

FIG. 7 is a graph comparing swell testing results for an example according to aspects of the present disclosure and a comparative example;

FIG. 8A is an image of point defects in a hardcoat layer according to some aspects of the present disclosure;

FIG. 8B is an image of point defects in a hardcoat layer according to some aspects of the present disclosure;

FIG. 9 is an image of failure modes of a transparent conductive oxide (TCO) and polyethylene terephthalate (PET) system;

FIG. 10 is a graph of sheet resistance as a function of time for examples with solvent temperature of 85° C. according to some aspects of the present disclosure;

FIG. 11 is a schematic of a solvent test set up according to some aspects of the present disclosure;

FIG. 12 is a graph of sheet resistance vs. exposure time for examples according to some aspects of the present disclosure;

FIG. 13 is a graph of sheet resistance vs. exposure time for examples according to some aspects of the present disclosure and comparative examples;

FIG. 14 is a graph of sheet resistance vs. exposure time according to some aspects of the present disclosure;

FIG. 15 is a graph of sheet resistance vs. exposure time according to some aspects of the present disclosure; and

FIG. 16 is a schematic diagram of a tortuous path as outlined in the present disclosure.

### DETAILED DESCRIPTION

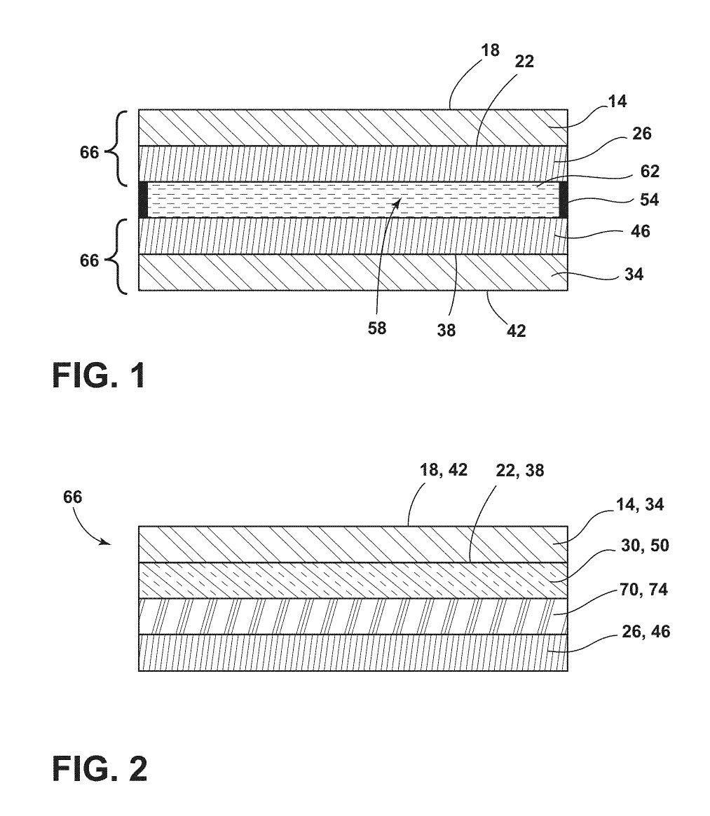

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Various embodiments are described hereinafter. It should be noted that the specific embodiments are not intended as an exhaustive description or as a limitation to the broader aspects disclosed herein. One aspect describing conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to a person of ordinary skill in the art, given the context in which it is used, “about” will mean up to +/−10% of the particular term period.

The use of the terms “a” and “an” and “the” and similar references in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value found within a range, unless otherwise indicated herein, and each separate value is incorporated in the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The term “substantially transparent” is used herein and will be understood by persons of ordinary skill in the art and will vary to some extent depending upon the context in which is it used. If there are uses of the term not clear to persons of ordinary skill in the art, given the context in which it is used, the term means that the material allows a light transmission of about 75% or more of a beam of light having a wavelength of 400 nanometers directed to the material at a specular angle of 10° through a thickness of 2 mm of the material. Further, “substantially transparent,” as it pertains to luminous transmittance, Y, encompasses substrates having luminous transmittance of greater than about 10%.

Referring to FIGS. 1-5D, the reference number 10 refers to an electro-optic element. The electro-optic element 10 includes a first substantially transparent substrate 14 defining first and second surfaces 18, 22. The second surface 22 includes a first electrically conductive layer 26. According to various examples, a first hardcoat layer 30 is disposed between the first substrate 14 and the first electrically conductive layer 26. A second substantially transparent substrate 34 defines third and fourth surfaces 38, 42. The third surface 38 includes a second electrically conductive layer 46. According to various examples, a second hardcoat layer 50 is disposed between the second substrate 34 and the second electrically conductive layer 46. A sealing member 54 is disposed between the first and second substrates 14, 34. The sealing member 54 and the first and second substrates 14, 34 cooperate to define a cavity 58 therebetween. An electrochromic medium 62 is positioned in the cavity 58 where the electrochromic medium 62 may include a cathodic and an anodic material.

The electro-optic elements 10 described herein may be included in, for example, a window, an aircraft transparency, a mirror, a display device, a light filter, a camera filter, and like electrochromic devices. It will be understood that like or analogous elements and/or components, and/or methods referred to herein, may be identified throughout the drawings with like reference characters. In some embodiments, the electro-optic element 10 may be included in an electrochromic device that is an electrochromic window, an electrochromic mirror, or the like. In some aspects, the electrochromic device is a vehicular interior electrochromic mirror. In some aspects, the electrochromic device is a variable transmission electrochromic window. In some embodiments, the electrochromic device is an aircraft window system. Other applications of electro-optic elements 10 used in electrochromic devices include screens for watches, calculators and computer display screens; eye wear such as eyeglasses and sunglasses; switchable mirrors, sun visors; automobile, architectural, aircraft, marine, and spacecraft windows; information display boards and digital billboards, and the like.

The solvent or solvents (also referred to as plasticizers) present in the electrochromic medium 62 can facilitate operation of the electro-optic element 10 through high ionic conductivity and/or high solubility of the electrochromic components. The solvents/plasticizers can be provided to enhance ion mobility within the electrochromic system to facilitate coloring and clearing of the electro-optic element 10. Generally, electrochromic systems which exhibit poor ion mobility will also exhibit slow coloring and clearing rates. For many commercial application, such as automotive sunroofs and architectural, automotive, and aerospace windows, fast coloring and clearing rates are desirable. While the solvents/plasticizers can facilitate operation of the electro-optic element 10, the solvents present within the electrochromic medium 62 may also harm or degrade the first and/or second substrates 14, 34 as well as the first and second electrically conductive layers 26, 46. Generally, as the amount of solvent/plasticizer present in an electrochromic system increases, a rate and/or degree of degradation may also increase. In addition, the elevated operational temperatures often experience in many commercial applications (e.g., sunroofs and windows) can also increase the rate at which the solvent/plasticizer degrades the electrically conductive layers 26, 46. The degradation of the first and second electrically conductive layers 26, 46 may be manifested as blisters and ultimately cracks in the presence of the electrochromic solvent at temperatures above about 45° C. The blisters may create undesirable visual effects during operation of the electro-optic element 10 without significantly affecting conductivity. Cracks in the electrically conductive layers 26, 46 can result in a decrease in conductivity of the electrically conductive layers 26, 46, which can adversely affect operation of the electro-optic element 10. Cracks in the electrically conductive layers 26, 46 may also create undesirable visual defects in the electro-optic element 10. By tailoring properties and constituents of the first and second substrates 14, 34 as well as the first and second electrically conductive layers 26, 46, the degradation may be minimized and/or eliminated. Aspects of the present disclosure relate to materials and structures that can decrease degradation of the first and second substrates 14, 34 and/or the first and second electrically conductive layers 26, 46 in the presence of certain electrochromic solvents/plasticizers under certain conditions. In one aspect of the present disclosure, a degree and/or rate of formation of blisters and cracks in the electrically conductive layer 26, 46 may be decreased. In one aspect, the materials and structures of the present disclosure facilitate a decrease in degradation of the electrically conductive layers 26, 46 and/or the substrates 14, 34. In one aspect, a decrease in degradation can be characterized by an increase in stability of a sheet resistance of the first and second electrically conductive layers 26, 46. According to one aspect, sheet resistance stability is defined by a change in sheet resistance of less than 20% after exposure to the electrochromic medium at 45° C. for 1000 hours, at a temperature of greater than 45° C. to about 85° C. for 1000 hours, and/or at 85° C. for 1000 hours.

Referring now to FIG. 1, traditional electro-optic elements or devices include the first substantially transparent substrate 14 defining the first and second surfaces 18, 22 where the second surface 22 is directly coupled to the first electrically conductive layer 26. The second substantially transparent substrate 34 defines the third and fourth surfaces 38, 42. The third surface 38 is coupled directly to the second electrically conductive layer 46. The sealing member 54 is disposed between the first and second substrates 14, 34. The sealing member 54 and the first and second substrates 14, 34 cooperate to define the cavity 58 therebetween. The electrochromic medium 62 is positioned in the cavity 58 where the electrochromic medium 62 includes the cathodic and the anodic material. It will be understood that the sealing member 54 is shown to be located between the second surface 22 on the first substrate 14 and the third surface 38 of the second substrate 34, but other configurations of the sealing member 54 are possible and within the scope and spirit of the present disclosure. The sealing member 54 may be positioned around the perimeter of the device as in a “C” configuration, may be remotely located, or any number of other configurations that will vary depending on the final use of the electro-optic device 10. For simplicity, herein, we refer to the sealing member 54 as being between the first and second substrates 14, 34 but this configuration should be understood to be non-limiting to the present disclosure and examples or descriptions of devices, unless explicitly noted, may be configured with different variations of the sealing member 54.

A substrate stack 66, as referenced and illustrated in FIGS. 1, 3A-3D, 4A-D, and 5A-5D, refers to either of the corresponding first and second substantially transparent substrates 14, 34 coupled, layered, and positioned with one or more of the different types of layers disclosed herein positioned in different combinations to prevent degradation and corresponding device failure caused by the degradation of the substrate 14 and/or 34 and their associated conductive layers 26 and 46, respectively. The substrate stack 66 illustrated in FIG. 1 is provided as a comparative example where the first and second substantially transparent substrates 14, 34 are coupled exclusively to the first and second electrically conductive layers 26, 46, respectively. Alternatively, the substrate stacks 66 illustrated in FIGS. 2, 3A-3D, 4A-D, and 5A-5D, represent and demonstrate the different combinations according to aspects of the present disclosure used to impart stability and/or EC efficiency in the electro-optic element 10. Although just one substrate stack 66 is illustrated in FIGS. 2, 3A-3D, 4A-D, and 5A-5D, the electro-optic element 10 is defined herein to include the sealing member, cavity 58, and electrochromic medium 62 positioned or sandwiched in between two, individual substrate stacks 66. In some aspects, the substrate stack 66 on each side of the electro-optic element 10 may include the same layering positioned on each side of the cavity 58 formed by the sealing member 54. In other aspects, each of the substrate stacks 66 may be different or two different sets of substrate stacks 66 can be positioned on each side of the cavity 58 depending on the desired properties and use of the corresponding electro-optic element 10 formed. In one aspect, the electro-optic element 10 can include a pair of any of the configurations of substrate stacks 66 described with respect to FIGS. 2, 3A-3D, 4A-D, and 5A-5D. In another aspect, the electro-optic element 10 includes a first substrate stack 66 selected from any of the configurations described with respect to FIGS. 2, 3A-3D, 4A-D, and 5A-5D and a second substrate stack 66 selected from any of the configurations described with respect to FIGS. 2, 3A-3D, 4A-D, and 5A-5D, which may be the same or different than the configuration of the first substrate stack 66. According to various examples and aspects described herein, illustrated in FIGS. 2, 3A-3D, 4A-D, and 5A-5D, each substrate stack 66 may include various combinations of a first antireflective (or color suppression layer) layer 70, a second antireflective (or color suppression) layer 74, a third hardcoat layer 78, a fourth hardcoat layer 82, a silver (Ag) stack layer 86, a transparent conductive oxide (TCO) layer 90 (e.g., an indium tin oxide layer), a first inorganic oxide or nitride layer 94, a second inorganic oxide or nitride layer 98, a first metal layer 102 and a second metal layer 106 in various combinations.

The first and/or second substrates 14, 34 of the electro-optic elements 10 described herein may be composed of a polymeric material, a glass, a glass-ceramic and/or combinations thereof. It will be understood that the first and second substrates 14, 34 may include the same type of material (i.e., both polymeric material) or that the material type may be different (i.e., one of the first and second substrates 14, 34 includes a polymeric material and the other a glass). The first and/or second substrates 14, 34 may be substantially transparent. In polymeric examples, the polymeric material of the first and/or second substrates 14, 34 may include polyethylene (e.g., low and/or high density), polyethylene terephthalate (PET), polyethylene naphthalate (PEN), polycarbonate (PC), polysulfone, acrylic polymers (e.g., poly(methyl methacrylate) (PMMA)), polymethacrylates, polyimides, polyamides (e.g., a cycloaliphatic diamine dodecanedioic acid polymer (i.e., Trogamid® CX7323)), epoxies, cyclic olefin polymers (COP) (e.g., Zeonor 1420R), cyclic olefin copolymers (COC) (e.g., Topas 6013S-04 or Mitsui Apel), polymethylpentene, cellulose ester based plastics (e.g., cellulose triacetate), transparent fluoropolymer, polyacrylonitrile, other polymeric materials and/or combinations thereof. In one aspect, the first and/or second substrates 14, 34 may include a dimensionally stabilized material, an example of which includes a heat stabilized PET material. Heat stabilization of the PET substrate material may reduce stress due to expansion and/or shrinkage of the material during heat cycles, which may enhance the lifespan of the materials used in the electro-optic elements 10. Other dimensionally stabilized materials include materials in which the first and/or second substrates 14, 34 have been laminated to a more rigid substrate material (e.g., glass) or materials in which a thickness of first and/or second substrates 14, 34 have been increased to provide the desired dimensional stability. Additionally or alternatively, materials with release liners coupled to the first and/or second substrates 14, 34 at the time of manufacture may be advantageous. Exemplary release liner coupled materials may include Peelable Clean Substrate (PCS) PET provided by Dupont Teijin. Such release liner coupled materials may have the benefit of minimizing defects as the release liner may be removed at the point of coating and thus the risk of contamination in preprocessing steps may be minimized or eliminated. It will be understood that the first and second substrates 14, 34 may have the same or a different compositions as one another.

Where both the first and second substrates 14, 34 include a polymeric material, the substrates 14, 34 may be flexible or rigid such that the electro-optic element 10 formed therefrom is a flexible or rigid electro-optic element 10.

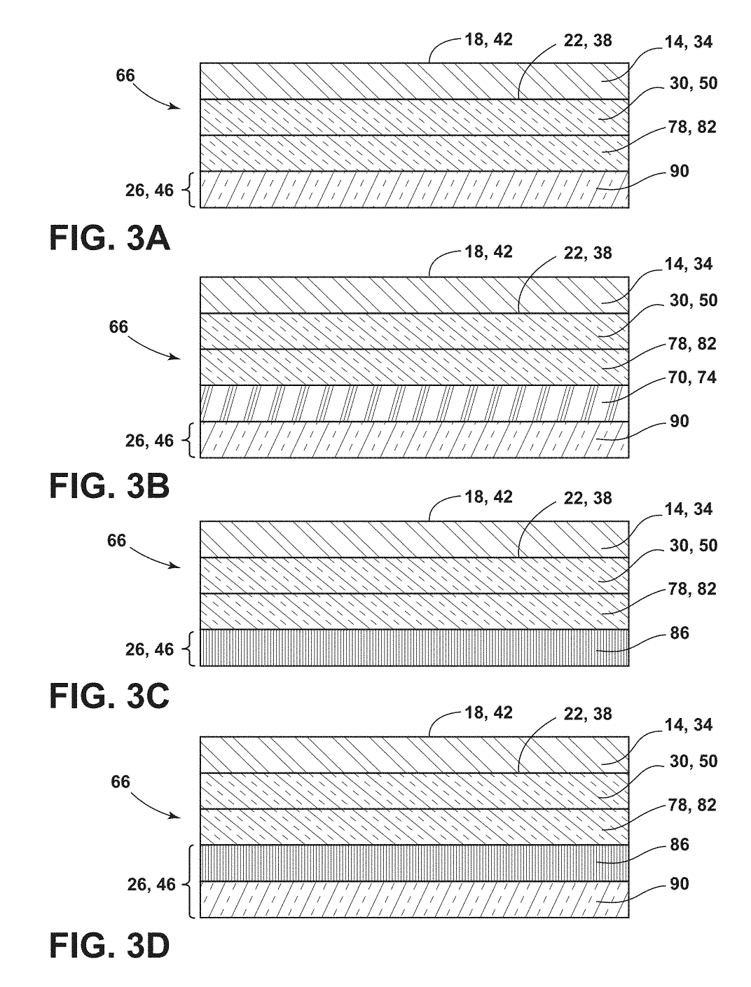

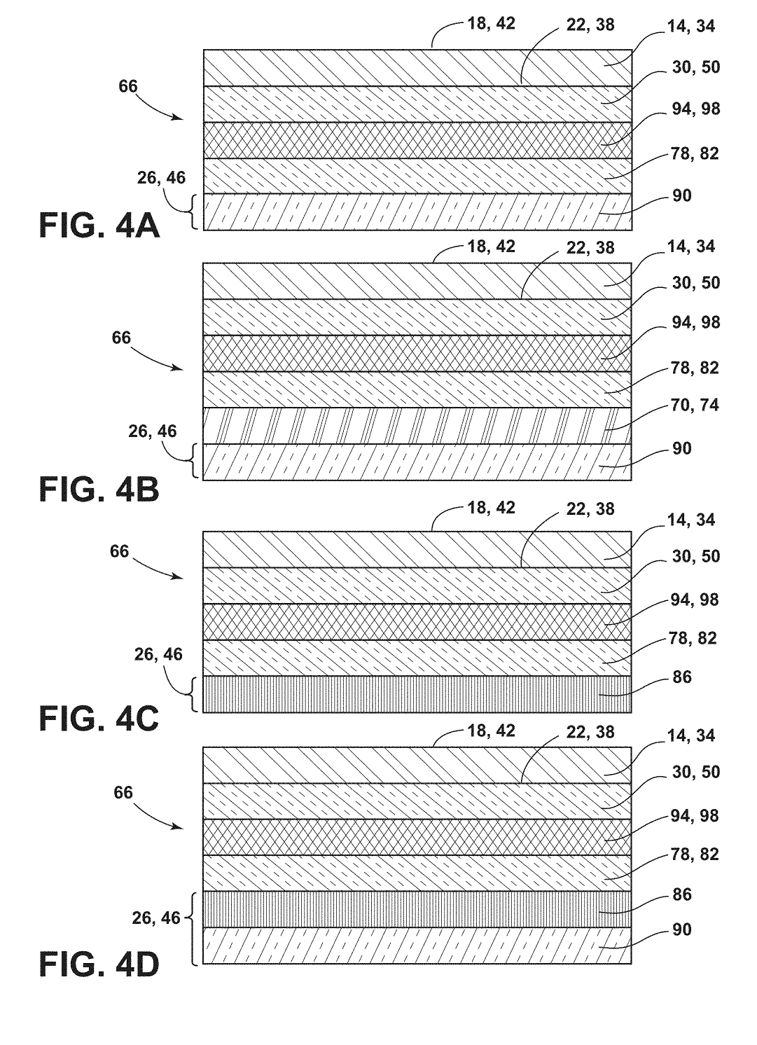

The first and second conductive layers 26, 46 may include the transparent conductive oxide (TCO) layer 90, the silver (Ag) stack layer 86, or a combination of the silver (Ag) stack layer 86 and the transparent conductive oxide (TCO) stacked in any order with respect to each other. An exemplary transparent conductive oxide (TCO) according to an aspect of the presented disclosure is indium tin oxide (ITO). In some aspects, the first conductive layer 26 may include the silver (Ag) stack layer 86 positioned between the transparent conductive oxide (TCO) layer 90 and the third hardcoat layer 78 (e.g., FIG. 4D). In other aspects, the first conductive layer 26 may include the transparent conductive oxide (TCO) layer 90 positioned between the silver (Ag) stack layer 86 and the third hardcoat layer 78. In still other aspects, the first and second conductive layers 26, 46 may include one or more transparent conductive oxide (TCO) layers 90. In other aspects, the first and second conductive layers 26, 46 may include one or more silver (Ag) stack layers 86. In yet other examples, the first and/or second conductive layers 26, 46 may form an insulator-metal-insulator (IMI) stack of any of the transparent conductive oxide (TCO) layer 90, the silver (Ag) stack layer 86 and one of the hardcoat layers 30, 50, 78, 82 (e.g., FIGS. 3D, 4D, 5D). Exemplary IMI stacks which may be utilized in combination with aspects of the present disclosure are disclosed in U.S. Pat. No. 8,368,992 and U.S. Application Publication No. 2018/0180923, the contents of which are incorporated herein by reference in their entirety. The conductive layer 26 may be referred to as an ITO layer, but it will be understood that the present disclosure is not limited to this particular material. Other transparent conducting oxides, such as fluorine-doped tin oxide (F:SnO₂), aluminum-doped zinc oxide (AZO), indium-doped zinc oxide (IZO), or the like may be used herein where ever ITO is called out and are within the scope of the present disclosure. In some embodiments where the substrate stack 66 is configured to form an IMI structure, the “I” layer above the silver (Ag) stack layer can be a conductive layer such as a transparent conductive oxide (TCO), while the lower “I” layer may be selected from the family of TCO's or other dielectric or insulating layers. Furthermore, the silver (Ag) stack layer is not limited to pure silver metal but may comprise alloys, mixtures, or dopants within the silver layer without deviating from the spirit of the present disclosure. One or more additional layers may be added to the IMI stack without deviating from the spirit of the disclosure.

In some aspects, the silver (Ag) stack layer 86 may include about 93 percent by weight (wt %) silver and about 7 wt % gold alloy. In other aspects, the silver (Ag) stack layer 86 may include from about 75 wt % to about 99.9 wt % silver and from about 25 wt % to about 0.1 wt % gold alloy. In still other aspects, the silver (Ag) stack layer 86 may include pure or nearly pure (e.g., greater than 99 wt % silver) silver. The addition of gold to the silver IMI stack is only one of several potential stabilization methods. Defects generated from electrical cycling could provide a partial path to the first and/or second substrates 14, 34 for solvent in the electrochromic medium 62. In particular, it has been experimentally observed that the addition of 7% by weight Au into Ag improves resistance to blister-like defect formation when an IMI stack undergoes electrochromic cycling as part of a system with anodic and cathodic species in solution when the IMI is used as the anode (+electrode) in a glass substrate system. Noble metals such as Au, Pt, and Pd, as well as well other elements such as In, Ti, Cu, Ni, and Zn within the silver layer may be potentially advantageous.

In another aspect, the first and second conductive layers 26, 46 include at least one layer deposited by atomic layer deposition (ALD) between the transparent electrode such as TCO (e.g., ITO) or an IMI stack and the ALD deposited layer may be selected from materials such as Al₂O₃ or TiO₂ or AZO.

The hardcoat layers disclosed herein, including the first, second, third, and fourth hardcoat layers 30, 50, 78, 82 may include any polymeric resin having a Shore D hardness of at least about 50, at least about 55, at least about 60, at least about 65, at least about 70, at least about 75, or at least about 80. In one aspect, the polymeric resin is characterized by a Shore D hardness of about 50 to about 100, about 55 to about 100, about 60 to about 100, about 65 to about 100, about 70 to about 100, about 75 to about 100, or about 80 to about 100. The stiffness of any of the hardcoat layers 30, 50, 78, 82 can be defined by its rigidity, its function of Young's modulus of hardcoat layer, layer thickness, and Poisson's ratio as provided in equation 1:

D=Eh³/12(1−v) (Eq. 1)

Where E is the Young's modulus, h is the layer thickness, and v is the Poisson's ratio. For the hardcoat layers 30, 50, 78, 82, the Poisson's ratio may be between about 0.2 to about 0.4. The thickness of the film has a significant effect on rigidity. The hardcoat layers 30, 50, 78, 82 delamination toughness is described by energy per square meter. A buffer layer with intermediate elastic modulus, can alleviate the elastic mismatch between the hardcoat layers 30, 50, 78, 82 and flexible examples of the first and/or second substrates 14, 34 and make crack propagation more difficult.

In some aspects, the first, second, third, and fourth hardcoat layers 30, 50, 78, 82 may be selected from acrylic polymer resins, siloxane based resins, polyethylene terephthalate (PET) resins, polyester resins, poly(methyl methacrylate) (PMMA), polycarbonate (PC) resins, or a combination thereof. In some aspects, the hardcoat layers 30, 50, 78, 82 may be applied as a melted or flowing polymer system. In other aspects, the hardcoat layers 30, 50, 78, 82 may be applied as a monomer or oligomeric system that is polymerized and/or crosslinked using UV light, E-beam, plasma, or any other initiation reaction known by those skilled in the art at atmospheric pressure or reduced pressure such as vacuum conditions. In some aspects, the hardcoat layers 30, 50, 78, 82 may be applied as a monomer or oligomeric system that is cured, polymerized, and/or crosslinked using plasma, E-beam or beta radiation. The surface quality of the first and/or second substrates 14, 34 prior to adding barrier layers (e.g., one of the hardcoat layers 30, 50, 78, 82) may be an important factor in minimizing point defects or stress points that could cause cracks in the subsequent coatings. Common examples of surface defects in the hardcoat layers 30, 50, 78, 82 include, but are not limited to, particles, belt marks, scratches, bumps from fillers, roller marks and residues. The thickness of the hardcoat layers 30, 50, 78, 82 may be larger than the average particle or scratch found on the layer and may be about 100 nanometer (nm) or greater, or about 1 micrometer (micron) in thickness.

In some aspects, the hardcoat layers 30, 50, 78, 82 may have a thickness from about 0.1 microns to about 10 microns, about 0.3 microns to about 100 microns, from about 0.1 microns to about 50 microns, from about 0.5 microns to about 30 microns, from about 5 microns to about 20 microns, or from about 10 microns to about 15 microns.

The main purpose of the sealing member 54 is to retard the permeation of oxygen and/or moisture into the electrochromic medium 62 which may cause premature degradation of the electro-optic element 10. The sealing member 54 can be used to join the first substrate 14 to the second substrate 34. In some embodiments, the first and second substrates 14 and 34 can be laminated together using the solidified or gelled electrochromic and ion conducting materials and the sealing member 54 can be applied to or laminated around the edge of first and second substrates 14, 34. If the first and second substrates 14, 34 are laminated between additional substrates with low gas permeation, such as two pieces of glass or rigid plastic, the sealing member 54 may seal the laminated article. In such an example, the sealing member 54 may include PVB or EVA. In some examples, the sealing member 54 may be recessed from the glass or rigid plastic edges of the additional substrates and a sealing material with low permeability may be applied around the perimeter of the first and second substrates 14, 34. The sealing member 54 may be an adhesive material applied to one of the first and second substrates 14, 34, or a dual system adhesive where a first component is applied to one substrate (e.g., the first substrate 14) and a second component is applied to the other substrate (e.g., the second substrate 34) and the two components combine on contact to bond the first and second substrates 14, 34 together. Illustrative adhesives for the sealing member 54 include, but are not limited to, those containing epoxies, urethanes, cyanoacrylates, acrylics, polyimides, polyamides, polysulfides, phenoxy resin, polyolefins, and silicones. The sealing member 54 may include a thermal cure system, such as a thermal cure epoxy, an ultraviolet light curable seal, or a combination of an ultraviolet light and thermal curing system.

The sealing member 54 may alternatively be a weld between the first substrate 14 and the second substrate 34. In other words, a melting and joining of two plastic examples of the first and second substrates 14, 34 to one another or using a third material such as when using a hot melt. Of course, care must be taken in application of the conductive materials on the surface of the first and second substrates 14, 34 such that shorting of the electro-optic element 10 does not occur. In some embodiments, the weld between the first and the second substrates 14, 34 is an ultrasonic weld. It should be noted that a combination of techniques could be used to seal the electro-optic element 10. For instance, a portion of the sealing member 54 could be formed by welding uncoated areas of the first and/or the second substrate 14, 34 together followed by applying a sealing adhesive that is UV cured to areas of the first and the second substrates 14, 34 that are coated with a coating such as a metal mesh coating or a nanowire coating.

The sealing member 54 may be a heat seal film which attaches to the first and second substrates 14, 34 at the edge of the first and second substrates 14, 34 around the circumference of the electro-optic element 10. Thus, the heat seal film covers an edge of the first surface 18 of the first substrate 14 and extends to an edge of the fourth surface 42 of the second substrate 34. This sealing member 54 provides a barrier for the electrochromic medium 62 or film from moisture and oxygen. The heat seal films are typically multi-layers consisting of an inner sealant layer, middle core layer, and outer barrier layer which may or may not include an metal foil layer. The film can be applied using a heat sealer to attach the film to the edge of the device. An example of a heat seal film without a foil layer includes Torayfan® CBS2 from Toray, and an example of a metallized heat seal film is Torayfan® PWXS from Toray. Additionally, a pressure-sensitive adhesive can be added to the inner sealant layer to adhere the film at room temperature or to improve adhesion during heat sealing. An example of a pressure sensitive adhesive for this purpose is 8142KCL from 3M®.

The anti-reflection layers, in the present disclosure, may perform the function of minimizing or eliminating the reflectance between adjacent layers. These are also known as index matching layers or color suppression layers. It is understood that known index matching or color suppression means may be used in this application to minimize the reflected or transmitted interferential color due to the thickness of the transparent conductive layer. The anti-reflection layer may comprise a single, fixed-index layer, a bi-layer or multi-layer, a graded refractive index layer, or combinations of these options. The first and second antireflective layers 70, 74 may be selected from materials whose refractive index meets the following requirement: RI_{AR}=Sqrt(RI_{SUB}*RI_{TCO}) where the RI_{SUB} is the refractive index of the substrate, hard coat, or layer below the anti-reflection layer and the RI_{TCO} is the refractive index of the TCO. Alternatively, the anti-reflection layer may comprise multiple layers of high refractive index (high index) materials and low refractive index (low index) materials, or a combination thereof whose net refractive index approximates the requirement defined above. In some aspects, the first and second antireflective layers 70, 74 may include high index materials including niobium oxide, titanium oxide, and tantalum oxide. In other aspects, the first and second antireflective layers 70, 74 may include low index materials including silicon oxide, magnesium fluoride, or combinations thereof. In some aspects, the low and high index materials may be deposited (e.g., sputtered, evaporated, etc. . . . ) directly onto the respective hardcoat layer or other layers disclosed and used herein for the substrate stack 66. In the case of a graded refractive index coating, the refractive index of the layer approximates the refractive index of the layer below the TCO at the interface to that layer, gradually changes in refractive index and approximately matches the refractive index of the TCO at the TCO interface. The thickness of the first and second antireflective layers 70, 74 can range from about 50 Å to about 2000 Å or from about 200 Å to about 1000 Å.

The first and second inorganic oxide or nitride layers 94, 98 may be selected from oxide materials including silicon oxide, silicon nitride, zinc tin oxide, aluminum oxide, tin oxide, hafnium oxide, other transparent oxide or nitride layers, or combinations or mixtures thereof. In some aspects, the oxide materials used for the first and second inorganic oxide or nitride layers 94, 98 may be deposited (e.g., sputtered, evaporated, etc. . . . ) directly onto the respective hardcoat layer or other layer disclosed and used herein for the substrate stack 66. Alternatively, ALD or other deposition methods may be used to create the first and/or second inorganic oxide layers 94, 98. Preferably the first and/or second inorganic oxide or nitride layers 94, 98 are deposited in an amorphous microstructure to minimize the diffusion of the blocked species through the layer. ALD is a particularly good deposition method because of its ability to conformally map the coating to the surface it is being deposited on. This maximizes density and minimizes defects thus helping achieve optimal barrier properties. In some examples, the thickness of first and/or second inorganic oxide or nitride layers 94, 98 can range from about 50 Å to about 2000 Å or from about 200 Å to about 1000 Å. As noted below, the inorganic layers 94, 98 may be positioned between hard coated layers 30, 50, 78, 82 such as PML deposited polymer layers. It will be understood that although the first and second inorganic oxide or nitride layers 94, 98 may be described herein as oxide layers for clarity, the first and second inorganic oxide or nitride layers 94, 98 may include oxides, nitrides and/or combinations thereof without departing from the teachings provided herein. According to various examples, the first and second inorganic oxide or nitride layers 94, 98 may be amorphous.

The first and/or second metal layers 102, 106 may be applied to the substrate stack 66 as a very thin layer. For example, an aluminum, silver, copper, or gold layer may be applied using an inkjet technology, where the sheet has a transmission to light having a wavelength of about 400 nm to about 700 nm of greater than 50% and a resistance of 0.1 Ω/sq, or less. This includes where the sheet has a transmission to light having a wavelength of about 400 nm to about 700 nm of greater than 60%, greater than 70%, or greater than 80%. This includes where the first and/or second metal layers 102, 106 have a transmission to light having a wavelength of about 400 nm to about 700 nm of 50% to 90%, or any range therebetween. The thickness of the first and/or second metal layers 102, 106 can range from about 50 Å to about 2000 Å or from about 200 Å to about 1000 Å.

In some aspects, the first and/or second metal layers 102, 106 may be applied by sputtering, vapor deposition, or inkjet technology and is referred to as an additive process. Other additive printing processes include gravure printing and screen printing. Subtractive methods can be used to form the pattern using etching or laser ablation.

The electrochromic medium 62 may take a number of different forms such as thermoplastic polymeric films, solution phase, or gelled phase. Illustrative electrochromic media 62 are those as described in U.S. Pat. Nos. 4,902,108; 5,888,431; 5,940,201; 6,057,956; 6,268,950; 6,635,194; and 8,928,966, the disclosures of which are all incorporated by reference herein in their entirety. The anodic and cathodic electrochromic materials can also include coupled materials as described in U.S. Pat. No. 6,249,369 and the concentration of the electrochromic materials can be selected as taught in U.S. Pat. No. 6,137,620, the disclosures of which are both incorporated by reference herein in their entirety. Additionally, a single-layer, single-phase medium may include a medium where the anodic and cathodic materials are incorporated into a polymer matrix.

The electrochromic medium 62 may be multi-layer or multiphase. In multi-layered, the medium 62 may be made up in layers and includes an electroactive material attached directly to an electrically conducting electrode or confined in close proximity thereto which remains attached or confined when electrochemically oxidized or reduced. In multiphase, one or more materials in the medium undergoes a change in phase during the operation of the device, for example, a material contained in solution in the ionically conducting electrolyte forms a separate layer on the electrically conducting electrode when electrochemically oxidized or reduced.

The electrochromic medium 62 may include materials such as, but not limited to, anodics, cathodics, light absorbers, light stabilizers, thermal stabilizers, antioxidants, thickeners, viscosity modifiers, tint providing agents, redox buffers, and mixtures thereof. Suitable redox buffers include, among others, those disclosed in U.S. Pat. No. 6,188,505, the disclosure of which is incorporated by reference herein in its entirety. Suitable UV stabilizers may include: 2-ethyl-2 cyano-3, 3-diphenyl acrylate, (2-ethylhexyl)-2-cyano-3,3-diphenyl acrylate, 2-(2′hydroxy-4′-methylphenyl)benzotriazole, 3-[3-(2Hbenzotriazole-2-yl)-5-(1, l-dimethylethyl)-4-hydroxyphenyl]propionic acid pentyl ester, 2,4-dihydroxybenzophenone, 2-hydroxy-4-methoxybenzophenone, 2-ethyl-2′-ethoxyalanilide, and the like.

According to some embodiments, the anodic materials may include, but are not limited to, ferrocenes, ferrocenyl salts, phenazines, phenothiazines, and thianthrenes. Illustrative examples of anodic materials may include di-tertbutyl-diethylferrocene; 5, 10-dimethyl-5, 10-dihydrophenazine (DMP); 3, 7, 10-trimethylphenothiazine, 2, 3, 7, 8-tetramethoxy-thianthrene, 10-methylphenothiazine, tetramethylphenazine (TMP), and bis(butyltriethylammonium)-para-methoxytriphenodithiazine (TPDT). The anodic materials may also include those incorporated into a polymer film such as polyaniline, polythiophenes, polymeric metallocenes, or a solid transition metal oxide, including, but not limited to, oxides of vanadium, nickel, iridium, as well as numerous heterocyclic compounds. Other anodic materials may include those as described in U.S. Pat. Nos. 4,902,108; 6,188,505; and 6,710,906, the disclosures of which are all incorporated by reference herein in their entirety.

In any of the above aspects, the anodic material may be a phenazine, a phenothiazine, a triphenodithiazine, a carbazole, an indolocarbazole, a biscarbazole, or a ferrocene confined within the second polymer matrix, the second polymer matrix configured to prevent or minimize substantial diffusion of the anodic material in the activated state. As with the viologen, the anodic material may be sequestered within the polymer matrix by being physically trapped within, or the anodic material may be functionalized such that it is amenable to being polymerized or reacted with the polymer to be covalently bonded to the polymer.

Cathodic materials may include, for example, viologens, such as methyl viologen, octyl viologen, or benzyl viologen; ferrocinium salts, such as (6-(tri-tertbutylferrocenium) hexyl)triethylammonium. It will be appreciated that all such species name only the cationic portion of the molecule and a wide variety of anions may be used as the counterion(s). While specific cathodic materials have been provided for illustrative purposes only, numerous other conventional cathodic materials are likewise contemplated for use including, but by no means limited to, those disclosed in previously referenced and incorporated U.S. Pat. Nos. 4,902,108, 6,188,505, and 6,710,906. Moreover, it is contemplated that the cathodic material may include a polymer film, such as various polythiophenes, polymeric viologens, an inorganic film, or a solid transition metal oxide, including, but not limited to, tungsten oxide.

Illustrative cathodic materials, for use in any of the devices described herein, include viologens and metal oxides. Illustrative metal oxides include those that are electrochromic such as tungsten oxide. Tungsten oxide may act as both a cathodic material as well as a conductive material.

In any of the above aspects, the cathodic material may be a viologen or a non-dimerizing or low-dimerizing viologen. Illustrative viologens include, but are not limited to, methyl viologen, octyl viologen, benzyl viologen, polymeric viologens, and the viologens described in U.S. Pat. Nos. 7,372,609; 4,902,108; 6,188,505; and 6,710,906, the disclosures of which are all incorporated by reference herein in their entirety.

Illustrative counterions/anions include, but are not limited to: F⁻, Cl⁻, Br⁻, I⁻, BF₄⁻, PF₆⁻, SbF₆⁻, AsF₆⁻, ClO₄⁻, SO₃CF₃⁻, N(CF₃SO₂)₂⁻, C(CF₃SO₂)₃⁻, triflate (trifluoromethanesulfonate), or BAr₄⁻, wherein Ar is an aryl or fluorinated aryl or a bis(trifluoromethyl)aryl group. In some embodiments, X is a tetrafluoroborate or a bis(trifluoromethylsulfonyl) imide anion.

The cathodic material may be a protic soluble electrochromic material (e.g., soluble in a protic solvent such as an alcohol and/or water), or a single component electrochromic material (i.e., the electrochromic material includes a compound that includes both cathodic and anodic moieties in the same molecule or cation/anion combination), such as described in U.S. Appl. Nos. 62/257,950 and 62/258,051 in addition to U.S. Pat. Nos. 4,902,108; 5,294,376; 5,998,617; 6,193,912; and 8,228,590, the disclosures of which are all incorporated by reference herein in their entirety.

For illustrative purposes only, the concentration of the anodic and/or cathodic materials in the electrochromic medium 62 can range from approximately 1 millimolar (mM) to approximately 500 mM and more preferably from approximately 2 mM to approximately 100 mM. While particular concentrations of the anodic as well as cathodic materials have been provided, it will be understood that the desired concentration may vary greatly depending upon the geometric configuration of the chamber containing the electrochromic medium 62.

For purposes of the present disclosure, a solvent of electrochromic medium 62 may include any of a number of common, commercially available solvents including 3-methylsulfolane, dimethyl sulfoxide, dimethyl formamide, tetraglyme and other polyethers; alcohols such as ethoxyethanol; nitriles, such as acetonitrile, glutaronitrile, 3-hydroxypropionitrile, and 2-methylglutaronitrile; ketones including 2-acetylbutyrolactone, and cyclopentanone; cyclic esters including beta-propiolactone, gamma-butyrolactone, and gamma-valerolactone; organic carbonates including propylene carbonate (PC), ethylene carbonate and methyl ethyl carbonate; and mixtures of any two or more thereof.

In some aspects, the electrochromic medium 62 includes a cathodic material and an anodic material. The cathodic material may include a viologen and the anodic material may include phenazine, a carbazole, an indolocarbazole, a biscarbazole, a ferrocene, or a combination thereof.

Provided are various examples of addressing degradation of components within the electro-optic element 10. While the separate examples may be described without reference to other examples for clarity, it will be understood that each of the below-described examples may be used in conjunction with any other example.

Substrates

The resistance of the electro-optic element 10 to attack by solvents (i.e., solvents present in the electrochromic medium 62) is, in some situations, related to the thickness of the substrate (i.e., the first and/or second substrates 14, 34). Generally, thicker examples of the first and/or second substrates 14, 34 are more solvent-resistant than thinner examples. Such a feature may be explained by mechanical loading of the first and/or second substrates 14, 34 and the resulting deflection. The deflection of the first and/or second substrate 14, 34 under a given load is a function of the Young's modulus of the material of the first and/or second substrate 14, 34. When a surface bending force is applied to the first and/or second substrate 14, 34 (i.e., with the first and/or second substrate 14, 34 being supported at opposite ends) there will be a stress neutral plane while a maximum compression stress will occur at the force surface and a maximum tension stress will exist on a surface on an opposite side of the first and/or second substrate 14, 34 to which the force is applied.

Provided in Table 1 is the surface stress of three polymeric materials which may be used in the first and/or second substrate 14, 34.

TABLE 1
Surface Stress Characteristics of Polymeric Substrate Materials.

| | Young's | | | | |
|---|---|---|---|---|---|
| | Modulus E | Thickness | Deflection y | 1/12*b*h³ | Surface Stress |
| | (psi) | (microns/inches) | (inches) | (inches⁴) | (psi) |
| PET* | 5.1 × 10⁵ | 50/0.002 | 6.43 | 6.4 × 10⁻¹¹ | 3.9 × 10⁴ |
| | 5.1 × 10⁵ | 125/0.0049 | 0.41 | 9.9 × 10⁻¹⁰ | 6.2 × 10³ |
| | 5.1 × 10⁵ | 270/0.011 | 0.04 | 1 × 10⁻⁸ | 1.3 × 10³ |
| PEN* | 7.5 × 10⁵ | 50/0.002 | 4.37 | 6.4 × 10⁻¹¹ | 3.9 × 10⁴ |
| | 7.5 × 10⁵ | 125/0.0049 | 0.28 | 9.9 × 10⁻¹⁰ | 6.2 × 10³ |
| | 7.5 × 10⁵ | 270/0.011 | 0.03 | 1 × 10⁻⁸ | 1.3 × 10³ |
| COP* | 4.4 × 10⁵ | 50/0.002 | 7.53 | 6.4 × 10⁻¹¹ | 3.9 × 10⁴ |
| | 4.4 × 10⁵ | 125/0.0049 | 0.48 | 9.9 × 10⁻¹⁰ | 6.2 × 10³ |
| | 4.4 × 10⁵ | 270/0.011 | 0.05 | 1 × 10⁻⁸ | 1.3 × 10³ |

*Data based on samples having length by width dimensions of 1 inch by 0.1 inches and an applied force (F) of 0.01 psi.

As can be seen from Table 1, surface stress decreases with increasing thickness of the first and/or second substrate 14, 34. Similarly, the deflection, y, is reduced as the thickness of the first and/or second substrate 14, 34 is increased. According to various examples, the thickness of the first and/or second substrate 14, 34 may be selected such that the calculated surface stress for a 1″ long and 0.1″ wide substrate with a 0.01 psi applied force is less than about 4×10⁴ psi, or less than about 1×10⁴ psi, or less than about 6×10³ psi. Further, the thickness of the first and/or second substrate 14, 34 may be sufficient so that the deflection is less than about 8″, or less than about 2″, or less than about 1″, or less than about 0.5″, or less than about 0.1″, about 0.01″ to about 8″, about 0.01″ to about 2″, about 0.01″ to about 1″, about 0.01″ to about 0.5″, about 0.01″ to about 0.1″, about 0.1″ to about 8″, about 0.1″ to about 2″, about 0.1″ to about 1″, about 0.1″ to about 0.5″, about 0.5″ to about 8″, about 0.5″ to about 2″, about 0.5″ to about 1″, about 1″ to about 8″, about 1″ to about 2″, or about 2″ to about 8″ under a 0.01 psi force for a sample having length and width dimensions of 1 inch and 0.1 inches, respectively. For example, the thickness of the first and/or second substrate 14, 34 may be about 50 microns or greater, or about 90 microns or greater, or about 120 microns or greater, about 200 microns or greater, about 50 microns to about 500 microns, about 50 microns to about 300 microns, about 50 microns to about 200 microns, about 50 microns to about 120 microns, about 50 microns to about 90 microns, about 90 microns to about 500 microns, about 90 microns to about 300 microns, about 90 microns to about 200 microns, about 120 microns to about 500 microns, about 120 microns to about 300 microns, about 120 microns to about 200 microns, about 200 microns to about 500 microns, or about 200 microns to about 300 microns. FIG. 14, discussed below, illustrates the effect of substrate thickness on sheet resistance for exemplary substrate stacks. Young's modulus of the substrate may be greater than about 3×10⁵, greater than about 5×10⁵, greater than about 7×10⁵, about 3×10⁵ to about 8×10⁵, about 3×10⁵ to about 7×10⁵, about 3×10⁵ to about 6×10⁵, about 3×10⁵ to about 5×10⁵, about 4×10⁵ to about 8×10⁵, about 4×10⁵ to about 7×10⁵, about 4×10⁵ to about 6×10⁵, about 4×10⁵ to about 5×10⁵, about 5×10⁵ to about 8×10⁵, about 5×10⁵ to about 7×10⁵, about 6×10⁵ to about 8×10⁵, about 6×10⁵ to about 7×10⁵, or about 7×10⁵ to about 8×10⁵.

Thinner examples of the first and/or second substrate 14, 34 can be made to work for a given application, or may be improved, by coupling or laminating the first and/or second substrate 14, 34 to a secondary rigid substrate that is more rigid than the polymeric material of the first and/or second substrate 14, 34 (e.g., glass) or an additional flexible substrate. FIG. 15, discussed below, illustrates the effect of laminating the first and/or second substrate 14, 34 to a more rigid substrate on the solvent resistance performance of the substrate stack. The lamination process may occur before or after application of the first and second electrically conductive layers 26, 46 to the first and/or second substrates 14, 34. One or more optional adhesive or tie layers can be provided to promote coupling or lamination of the first and/or second substrate 14, 34 to the secondary substrate. In one aspect, the first and/or second substrate 14, 34 can be laminated or otherwise coupled with a secondary substrate having a higher rigidity, as characterized by a higher flexural modulus, compared to a rigidity of the corresponding laminated first and/or second substrate 14, 34. In one example, the secondary substrate is a glass. In one aspect, a thickness of the first and/or second substrate 14, 34 can be selected in combination with the laminating materials such that a deflection of the laminated first and/or second substrate 14, 34 is less than about 8″, or less than about 2″, or less than about 1″, or less than about 0.5″, or less than about 0.1″, about 0.01″ to about 8″, about 0.01″ to about 2″, about 0.01″ to about 1″, about 0.01″ to about 0.5″, about 0.01″ to about 0.1″, about 0.1″ to about 8″, about 0.1″ to about 2″, about 0.1″ to about 1″, about 0.1″ to about 0.5″, about 0.5″ to about 8″, about 0.5″ to about 2″, about 0.5″ to about 1″, about 1″ to about 8″, about 1″ to about 2″, or about 2″ to about 8″, under a 0.01 psi force for a sample having length and width dimensions of 1 inch and 0.1 inches, respectively.

The stiffness or rigidity of the first and/or second substrate 14, 34 may prevent bending on a short length scale. As discussed above, the first and second substrates 14, 34 can be configured to provide the desired stiffness/rigidity by selecting a predetermined thickness and/or by laminating or otherwise coupling the first and second substrates 14, 34 to a secondary, more rigid substrate. The durability of the first and second electrically conductive layers 26, 46 to solvent attack can be improved via appropriate stiffness of the first and/or second substrate 14, 34. One or more of the first, second, third, and fourth hardcoat layers 30, 50, 78, 82 can be applied to further strengthen a surface of a polymeric example of the first and/or second substrate 14, 34. The hardness, stiffness, and toughness of the hardcoat layers 30, 50, 78, 82 can be used to minimize the localized bending of the first and/or second substrates 14, 34 thus minimizing the flexing of the first and second electrically conductive layers 26, 46. In one aspect, a thickness, stiffness, and/or rigidity of the first and/or second substrate 14, 34 can be selected in combination with the one or more of the first, second, third, and fourth hardcoat layers 30, 50, 78, 82 such that a deflection of the combined stack is less than about 8″, or less than about 2″, or less than about 1″, or less than about 0.5″, or less than about 0.1″, about 0.01″ to about 8″, about 0.01″ to about 2″, about 0.01″ to about 1″, about 0.01″ to about 0.5″, about 0.01″ to about 0.1″, about 0.1″ to about 8″, about 0.1″ to about 2″, about 0.1″ to about 1″, about 0.1″ to about 0.5″, about 0.5″ to about 8″, about 0.5″ to about 2″, about 0.5″ to about 1″, about 1″ to about 8″, about 1″ to about 2″, or about 2″ to about 8″, under a 0.01 psi force for a sample having length and width dimensions of 1 inch and 0.1 inches, respectively.

Hardcoat Layers

The first and second electrically conductive layers 26, 46 change electrical conductivity by developing blisters and, ultimately, cracks which lead to lack of continuity and thus increased sheet resistance or development of localized defects. Localized defects can cause light or dark defects in the darkening or clearing of the electrochromic part. Degradation of the first and second electrically conductive layers 26, 46 may result in the sheet resistance of the first and second electrically conductive layers 26, 46 changing with time. Often the change in sheet resistance occurs due to the exposure of the first and second electrically conductive layers 26, 46 to a solvent of the electrochromic medium 62. Depending on the application, the exposure temperature may be greater than about 50° C., greater than about 70° C., or greater than about 85° C. The sheet resistance should remain relatively constant over the exposure times. Stability pertains to the consistency of sheet resistance needed for the electro-optic element 10 to maintain switching performance as the sheet resistance changes. This may mean that the uniformity of transmittance in the darkened state matches the uniformity profile of the original device or that the time to switch is relatively constant. In one aspect, the substrate stacks 66 of the present disclosure are configured to improve the stability of the electro-optic element 10. As used herein, the stability of the electro-optic element 10 can be defined based on a stability of the sheet resistance of the first and/or second electrically conductive layers 26, 46. In one aspect, stability can be based on a magnitude of a change in sheet resistance of less than about 25 ohm/sq, less than about 10 ohm/sq, less than about 5 ohm/sq, less than about 2 ohm/sq, or less than about 1 ohm/sq. In another aspect, stability can be characterized in terms of a percent change in sheet resistance of the first and/or second electrically conductive layers 26, 46. The sheet resistance change may be less than about 20%, less than about 10%, or less than about 5% relative to an initial value. According to one aspect, the first and second electrically conductive layers 26, 46 are characterized by a change in sheet resistance of less than 20% after exposure to the solvent of the electrochromic medium at 45° C. for 1000 hours. In one aspect, the first and second electrically conductive layers 26, 46 are characterized by a change in sheet resistance of less than 10% or less than 5% after exposure to the solvent of the electrochromic medium at 45° C. for 1000 hours. The first and second electrically conductive layers 26, 46 with higher sheet resistance will have a larger change in sheet resistance with comparable degradation to first and/or second electrically conductive layers 26, 46 with lower sheet resistance.

The use of propylene carbonate as a solvent used to apply traditional EC chemistry at elevated temperatures frequently degrades conductive ITO layers coated on a plastic substrate such as polyethylene terephthalate (PET) causing defects and the ultimate failure of the EC device. It has been discovered that the application of certain combinations of the first, second, third, and/or fourth hardcoat layers 30, 50, 78, 82 placed between the first and/or second substrates 14, 34 and the TCO layer 90 can minimize or almost entirely eliminate degradation of the TCO layer 90.

The hard, brittle film-like transparent conductive oxide (TCO) layer 90, which may be a ceramic film layer, typically has a Young's modulus of >100 GPa and a coefficient of thermal expansion less than 10 ppm/° C. The flexible materials used for the first and second substrates 14, 34, like PET and PEN, have a Young's modulus as <10 GPa and coefficient of thermal expansion about 20 ppm/° C. The thermal and mechanical mismatch between the hard, brittle film of the TCO layer 90 and the flexible substrate 14, 34 may lead to cracking and delamination of the TCO layer 90 during the fabrication process and in operation. The absence of cracks on the hard, brittle film TCO layer 90 at a small strain as close as 1.5% can be attributed to the compressive residual stress of the hard, brittle film TCO layer 90 which was developed during cooling after the coating process.

Adhesion sensitivity depends on processing conditions, on materials deliberately added to the interface, and on impurities segregated to the interface of the hard, brittle coating and flexible substrate. Brittle film can survive significant compressive strain in its plane if it is well bonded to the flexible substrate. But poorly bonded hard coating films form channel cracks at small strain. Small grain size and inadequate interfacial adhesion cause cracks in hard, brittle film coating. When the crack just begins to grow from the flaw, the length of the crack is typically smaller than, or comparable to, the thickness of the film. When a dislocation reaches the interface, the interface may de-bond or even slide allowing the dislocation to form a step. Slip steps at the interface and incipient de-bonds may act as nucleation sites for interfacial cracks that result in delamination of the film and strain. The crack's density is thought to be determined by the fracture strength and the interfacial strength between the hard, brittle film and flexible substrate. Moisture and/or solvents may participate in the process of breaking atomic bonds along the crack front and assist the cracking.

The strength of the hard, brittle film is also thought to increase as the thickness of film decreases. This can cause a problem if thicker layers are needed to attain the desired sheet resistance or to attain a given optical effect. Thicker flexible examples of the first and/or second substrates 14, 34 are suggested to facilitate the prevention of buckling delamination. According to various examples, the first and second conductive layers 26, 46 may comprise a barrier layer under the silver (Ag) stack layer 86 and the TCO layer 90 (e.g., indium tin oxide) made of a layer deposited via ALD. The ALD layer may be a transparent conducting oxide and/or may be amorphous. In another aspect, the first and second conductive layers 26, 46 may be overcoated with a transparent conducting oxide layer, such as indium tin oxide, via ALD with thickness smaller than 15 nm, preferably thinner than 5 nm such that the interstitial spaces of the sputtered coating are covered by the ALD deposited TCO coating.

The propagation of cracks in the first and/or second electrically conductive layers 26, 46, formed by bending (localized or macroscopic), can be slowed or minimized by altering the stress in the first and/or second electrically conductive layers 26, 46. The stress may be modified in a number of manners such as pressure of deposition, temperature, or the other factors during deposition of the layers of the first and/or second electrically conductive layers 26, 46. Alternatively, cracks may propagate due to bond strength between the cracking layer and an adjacent surface. Increasing the strength of the bond or altering the interface chemistry to minimize crack propagation can improve stability of the sheet resistance of the first and/or second electrically conductive layers 26, 46. The resistance of the first and/or second electrically conductive layers 26, 46 may be affected by the crystallinity of the layer with amorphous materials potentially being stronger due to lack of crystal defect lines that may allow or enhance crack propagation. The proliferation of cracks due to defect origins may be mitigated by applying a first smoothing layer or layers to the first and/or second substrates 14, 34. The first, second, third, and/or fourth hardcoat layers 30, 50, 78, 82 may perform multiple roles in this regard. The adhesion between the first and/or second substrates 14, 34 and the first and/or second electrically conductive layers 26, 46 may be affected by impurities in the first and/or second substrates 14, 34. The activity of the impurities, with regard to crack formation and propagation, may be enhanced by the presence of the solvent at the interface. The solvent, at the interface, may be minimized or eliminated by creating a tortuous path for the solvent to get to the interface of the first and/or second substrates 14, 34.

Polymer Multi-Layers

Thin film delamination (e.g., the first and/or second electrically conductive layers 26, 46) due to stress corrosion is one of the primary causes of adhesion loss of thin films on a plastic component (e.g., the first and/or second substrates 14, 34) upon exposure to a solvent medium (e.g., the electrochromic medium 62) at elevated temperatures. The molecules composing the solvent diffuse through the thin film and interact with the plastic component creating an increase of volume that could be accompanied by a chemical reaction further breaking chemical bonds and lowering adhesion strength. This increase in volume creates a residual stress in addition to other stresses such as thermal stresses or residual stress in the thin film from the deposition process. Therefore, to prevent the solvent from interacting with the first and/or second substrates 14, 34, a mechanism must be present to prevent the solvent from passing through the first and/or second electrically conductive layers 26, 46. Without being limited by any theory, there are two main theories applicable to how this mechanism works that can be used in a complementary fashion. One is the barrier theory and the other is the tortuous path theory. In barrier theory one medium is separated from another medium by a barrier that is completely impermeable to the mobile species of interest, for example, solvent molecules. In a simplified model of diffusion, the species moving through a uniform material would move following a Brownian motion, all directions having the same probability and the time to reach a location would be determined mainly by the diffusion coefficient. However, if we introduce domains to this medium where it is more difficult for molecules to move through, it forces the molecules to go around the domains of low or null diffusion. This deviation of the standard Brownian motion is the basis of the tortuous path theory. The diffusing species is still capable of passing through, but the tortuous path creates an effectively longer distance for the molecules to travel than if there would be no obstacles, therefore delaying the process.

According to various examples, one or more of the hardcoats 30, 50, 78, 82 disclosed herein may be deposited, applied and/or included in a polymer multi-layer film used to form the substrate stack 66. Polymer multi-layer (PML) films, such as the Flexible Transparent Barrier (FTB) Films offered by 3M™, typically consist of alternating layers of crosslinked polymer and inorganic barrier to form optically clear, flexible, oxygen and water barriers. The first polymer layer is applied to the plastic film substrate via flash evaporation and vapor deposition of monomers followed by a plasma, UV, or e-beam curing. The first polymer layer could also be applied via printing, slot die coating, or spraying followed by UV or e-beam curing. In one aspect, an adhesion promotion layer may be provided between the plastic film substrate and the first polymer layer. The adhesion promotion layer may be any of the adhesion layers or adhesion promotion layers described herein. In one example, the adhesion promotion layer may be a thin layer of a metal (e.g., Cr or Ti), metal oxide, or oxynitride layer deposited on the plastic film substrate prior to application of the barrier layers or hardcoats. The inorganic barrier layer is applied next using conventional sputtering, evaporation, atomic layer deposition, and/or other deposition methods. The final polymer layer is applied on top of the inorganic barrier layer using the flash evaporation method or other methods listed above. The polymer layers can range in thickness from about 2 nanometers to 10 microns, or from 0.5 to 1.5 microns. The inorganic barrier layers can range in thickness from about 3 nanometers to about 150 nanometers, or from about 5 nanometers to about 75 nanometers. The polymer layers are comprised of volatile monomers which can be crosslinked into transparent polymers. Optionally, the surface of the plastic film substrate can be surface activated, such as by plasma treatment, prior to deposition of the monomers on the substrate (e.g., prior to flash evaporation deposition of the monomers). Example monomers are diacrylates available from Sartomer® such as SR833S and SR9003B. Suitable inorganic barrier materials include metal oxides, metal nitrides, and combinations of each. Example inorganic barrier layers include silicon oxide, silicon nitride, zinc tin oxide, aluminum oxide, tin oxide, hafnium oxide, other transparent oxide or nitride layers, or combinations or mixtures thereof.

An alternating structure of a polymer layer with an oxide layer is the basis for a multi-layer coating that can create a tortuous path for solvent, water, oxygen, and/or other molecules to get to the first and/or second substrates 14, 34. It is recognized that it is often impractical to make a single layer coating that is defect free. The defects can lead to enhanced diffusion pathways for the molecules to get to the first and/or second substrates 14, 34. In the areas between the defects, the coatings may provide adequate diffusion barriers and thus protect the first and/or second substrates 14, 34. In the areas of the defects, the molecules enter the multi-layer coating at a defect but then must find the next defect to be able to proceed toward the first and/or second substrates 14, 34. By employing the alternating polymer and inorganic barrier layer structure, the diffusion rate through the multi-layer coating parallel to the first and/or second substrates 14, 34 is greatly reduced because the pathway is greatly increased. Once the molecule finds the next defect it must then diffuse along yet another layer to find yet another defect to continue its journey to the substrate. This concept is known as a tortuous path because a simple multi-layer provides improved diffusion properties through creating effectively longer diffusion pathways. The complexity of the multi-layer coating may vary from a single inorganic barrier/polymer bi-layer to a polymer/inorganic barrier/polymer tri-layer, or additional inorganic barrier/polymer pairs (dyad) may be added to provide increased diffusion properties.

Although the concept of a tortuous path was introduced as it relates to barrier layers, it will be understood that IMI stacks described herein may also function as a tortuous path and thus improve the solvent resistance of the electro-optic element 10 compared to a single metal or TCO layer.

In certain examples, an electron transfer layer may be in contact with the electrochromic medium 62. In other words, the polymer multi-layer films may be positioned between the first and/or second electrically conductive layers 26, 46 and the respective first and second substrates 14, 34. Exemplary materials for the electron transfer layer include transparent conductive oxides, for example, ITO, AZO, IZO, ZnO, and metallic see-through layers or a combination of TCOs and see-through metallic layers with a transmission larger than 30% and with a sheet resistance preferably lower than 200 ohms/sq, preferably lower than 40 ohms/sq and most preferably less than 20 ohms/sq. Magnetron sputtering coatings of TCOs consist of grains or crystals of length scales in the nm scale with interstitial spaces between the grains forming pores through which the solvent material is able to diffuse and reach the opposite side of the sputtered film. Such an example where the polymer multi-layer film is positioned between the electron transfer layer or the first and/or second electrically conductive layers 26, 46 and the respective first and second substrates 14, 34 may be advantageous to slow diffusion of the solvent molecules.

Adhesion Layers

One issue that is prevalent with transparent conductive oxide (TCO) coatings on plastic substrates is the inability to achieve a sufficiently low sheet resistance for the electro-optic element 10. Typical sheet resistance ranges from 15-100 ohms/sq and higher while insulator-metal-insulator (IMI) layers are typically in the 2-20 ohms/sq range or less. Thicker or lower sheet resistance TCO layers slightly delayed the failure mechanisms mentioned previously, but ultimately showed the same failure mechanisms and lost conductivity. Different applications, such as electro-optic devices or liquid crystal devices, have different constraints in relation to sheet resistance or conductivity of the transparent electrode. Electro-optic materials rely on relatively large current flow to function optimally while liquid crystal devices, being field effect devices, have less stringent needs from a sheet resistance perspective. Therefore, electro-optic devices function well with low sheet resistance, but liquid crystals may function with higher sheet resistance for the transparent electrodes. The second surface 22 of the first substrate 14 and the third surface 38 of the second substrate 34 include conductive materials or layers 26, 46, respectively. Where the second substrate 34 is a metal, the sheet resistance is sufficiently low, however for the first substrate 14, which is substantially transparent, the second surface 22 includes a conductive material to provide the first electrically conductive layer 26 on the first substrate 14. For example, the conductive material may be a TCO such as indium tin oxide (ITO), indium zinc oxide (IZO), zinc oxide, and tin oxide. However, where flexibility is to be exhibited by at least the first substrate 14, and particularly where both substrates 14, 34 are flexible or rigid, indium tin oxide is quite brittle and may not survive repeated flexing and may delaminate.

One problem with coatings on polymeric examples of the first and/or second substrates 14, 34, in particular on substrates that tend to be chemically inert, such as COCs, COPs or fluoropolymers, is that without adhesion promotion layers or substrate surface activation prior to applying the first and/or second electrically conductive layers 26, 46, the conductive layers 26, 46 would be prone to have areas with delamination. The delamination of the first and/or second electrically conductive layers 26, 46 provides channels for the penetration of oxygen or water vapor into the cavity 58, in particular if there is delamination near the sealing member 54. Alternatively, delamination happening near the center of the electro-optic element 10 also would cause openings for oxygen or water vapor in an optional gas diffusion barrier and therefore defeat its purpose. Accordingly, an adhesion promotion layer may be applied to the second and/or third surfaces 22, 38, a see-through, or optically transparent, layer of a metallic or sub-stoichiometric oxide or nitride or combination thereof. This adhesion promotion layer may include one or more metals that are relatively easy to oxidize, that is, that have an oxide heat of formation less than −3 eV per oxygen atom such as zinc, tantalum, aluminum, titanium, silicon or chromium, preferably chromium, coated preferably using magnetron sputtering, with a thickness lower than 20 nm, preferably lower than 10 nm, and a transmission to light having a wavelength of about 400 nm to about 700 nm that is greater than 50%. In one aspect, the adhesion promotion layer may be a translucent layer of a metal coating, such as aluminum, titanium, copper, or chromium, which is optionally coated using magnetron sputtering, and which is characterized by a thickness lower than 20 nm, optionally lower than 5 nm, and a transmission to light having a wavelength of about 400 nm to about 700 nm of about 50%. A polymer based adhesion promotion layer or primer may be employed such as a polyimide coating. The first and/or second substrates 14, 34 may be surface activated prior to coating using a plasma (vacuum or atmospheric) or corona discharge, using air or a mixture of gases such as nitrogen, argon and oxygen. Another option is the use of ion beam etching in a vacuum environment, also using gases such as oxygen and nitrogen, where the ion energy can be between 100 to 5000 keV and the ion dosage at 1×10¹⁴ to 1×10¹⁸. Other options for surface activation are oxygen plasma etch and ultraviolet light in ozone atmosphere. Yet another option for the activation of the surface is the use of flame treatment, and the use of SiO₂ flame pyrolysis treatment.

Electro-Optic Configurations

Provided in FIGS. 2, 3A-3D, 4A-4D, and 5A-5D are a variety of configurations of the substrate stack 66 of the electro-optic element 10 incorporating the components described above and in configurations based upon the principles in the above disclosure.

Referring now to FIG. 2, the substrate stack 66 includes the first substantially transparent substrate 14 defining first and second surfaces 18, 22 where the second surface includes the first electrically conductive layer 26. The first hardcoat layer 30 is disposed between the first substrate 14 and the first conductive layer 26 and a first anti-reflective layer 70 is disposed between the first hardcoat layer 30 and the first conductive layer 26.

The electro-optic element 10 incorporating the substrate stack 66 illustrated in FIG. 2 may include: the first substantially transparent substrate 14 defining first and second surfaces 18, 22, where the second surface 22 includes the first electrically conductive layer 26; the first hardcoat layer 30 disposed between the first substrate 14 and the first conductive layer 26; the second substantially transparent substrate 34 defining third and fourth surfaces 38, 42, where the third surface 38 includes the second electrically conductive layer 46; the second hardcoat layer 50 disposed between the second substrate 34 and the second conductive layer 46; the sealing member 54 (FIG. 1) disposed between the first and second substrates 14, 34, wherein the sealing member 54 and the first and second substrates 14, 34 define the cavity 58 therebetween; and the electrochromic medium 62 positioned in the cavity 58, where the electrochromic medium 62 comprises the cathodic and the anodic material. The electro-optic element 10 further includes a first antireflective layer 70 disposed between the first hardcoat layer 30 and the first conductive layer 26 in addition to a second antireflective layer 74 disposed between the second hardcoat layer 50 and the second conductive layer 46.

Referring now to FIGS. 3A, 3C, and 3D, the substrate stack 66 includes the first substantially transparent substrate 14 defining the first and second surfaces 18, 22 where the second surface 22 includes the first electrically conductive layer 26. The first hardcoat layer 30 is disposed between the first substrate 14 and the first conductive layer 26. A third hardcoat layer 78 is disposed between the first hardcoat layer 30 and the first conductive layer 26. The conductive layer 26 may include an transparent conductive oxide (TCO) layer 90 as provided in FIG. 3A, a silver (Ag) stack layer 86 as provide in FIG. 3C, or a combination conductive layer including the silver (Ag) stack layer 86 and the transparent conductive oxide (TCO) layer 90 stacked in any order. In some aspects, the first conductive layer 26 may include the silver (Ag) stack layer 86 positioned between the transparent conductive oxide (TCO) layer 90 and the third hardcoat layer 78 as illustrated in FIG. 3D. As provided in FIG. 3B, the first anti-reflective layer 70 can be disposed between the third hardcoat layer 78 and the first conductive layer 26, and may be included in any of the substrate stacks 66 of FIGS. 3A, 3D, and 3D.

The electro-optic element 10 incorporating the substrate stacks 66 illustrated in FIGS. 3A-3D may include: the first substantially transparent substrate 14 defining first and second surfaces 18, 22, where the second surface 22 includes the first electrically conductive layer 26; the first hardcoat layer 30 disposed between the first substrate 14 and the first conductive layer 26; the second substantially transparent substrate 34 defining third and fourth surfaces 38, 42, where the third surface 38 includes the second electrically conductive layer 46; the second hardcoat layer 50 disposed between the second substrate 34 and the second conductive layer 46; the sealing member 54 disposed between the first and second substrates 14, 34, wherein the sealing member 54 and the first and second substrates 14, 34 define the cavity 58 therebetween; and the electrochromic medium 62 positioned in the cavity 58, where the electrochromic medium 62 comprises the cathodic and the anodic material. The electro-optic element 10 using the substrate stack of FIGS. 3A-3D additionally includes the third hardcoat layer 78 disposed between the first hardcoat layer 30 and the first conductive layer 26 and a fourth hardcoat layer 82 disposed between the second hardcoat layer 50 and the second conductive layer 46. The electro-optic element 10 using the substrate stack of FIG. 3B additionally includes the first antireflective layer 70 disposed between the first hardcoat layer 30 and the first conductive layer 26 in addition to the second antireflective layer 74 disposed between the second hardcoat layer 50 and the second conductive layer 46.

Referring now to FIGS. 4A, 4C, and 4D, the substrate stack 66 includes the first substantially transparent substrate 14 defining first and second surfaces 18, 22 where the second surface 22 includes the first electrically conductive layer 26. The first hardcoat layer 30 is disposed between the first substrate 14 and the first conductive layer 26. The third hardcoat layer 78 is disposed between the first hardcoat layer 30 and the first conductive layer 26. A first inorganic oxide or nitride layer 94 is disposed between the first hardcoat layer 30 and the third hardcoat layer 78. The conductive layer 26 may include a transparent conductive oxide (TCO) layer 90 as provided in FIGS. 4A and 4B, a silver (Ag) stack layer 86 as provided in FIG. 4C, or a combination conductive layer including the silver (Ag) stack layer 86 and the transparent conductive oxide (TCO) layer 90 stacked in any order. In some aspects, the first conductive layer 26 may include the silver (Ag) stack layer 86 positioned between the transparent conductive oxide (TCO) layer 90 and the third hardcoat layer 78 as illustrated in FIG. 4D. Referring to FIG. 4B, the first anti-reflective layer 70 can be disposed between the third hardcoat layer 78 and the first conductive layer 26. The first anti-reflective layer 70 can be used with any of the configurations of FIGS. 4A, 4C, and 4D.

The electro-optic element 10 incorporating the substrate stacks 66 illustrated in FIGS. 4A-4D may include: the first substantially transparent substrate 14 defining first and second surfaces 18, 22, where the second surface 22 includes the first electrically conductive layer 26; the first hardcoat layer 30 disposed between the first substrate 14 and the first conductive layer 26; the second substantially transparent substrate 34 defining third and fourth surfaces 38, 42, where the third surface 38 includes the second electrically conductive layer 46; the second hardcoat layer 50 disposed between the second substrate 34 and the second conductive layer 46; the sealing member 54 disposed between the first and second substrates 14, 34, wherein the sealing member 54 and the first and second substrates 14, 34 define the cavity 58 therebetween; the electrochromic medium 62 positioned in the cavity 58, where the electrochromic medium 62 comprises the cathodic and the anodic material; the third hardcoat layer 78 disposed between the first hardcoat layer 30 and the first conductive layer 26; and the fourth hardcoat layer 82 disposed between the second hardcoat layer 50 and the second conductive layer 46. The electro-optic element 10 using the substrate stack of FIGS. 4A-4D additionally includes the first inorganic oxide or nitride layer 94 disposed between the first hardcoat layer 30 and the third hardcoat layer 78 and a second inorganic oxide or nitride layer 98 disposed between the second hardcoat layer 50 and the fourth hardcoat layer 82. The electro-optic element 10 using the substrate stack 66 of FIG. 4B additionally includes the first antireflective layer 70 disposed between the third hardcoat layer 78 and the first conductive layer 26 in addition to the second antireflective layer 74 disposed between the fourth hardcoat layer 82 and the second conductive layer 46. The first and second anti-reflective layers 70 and 74 can be used with any of the configurations of FIGS. 4A, 4C, and 4D.

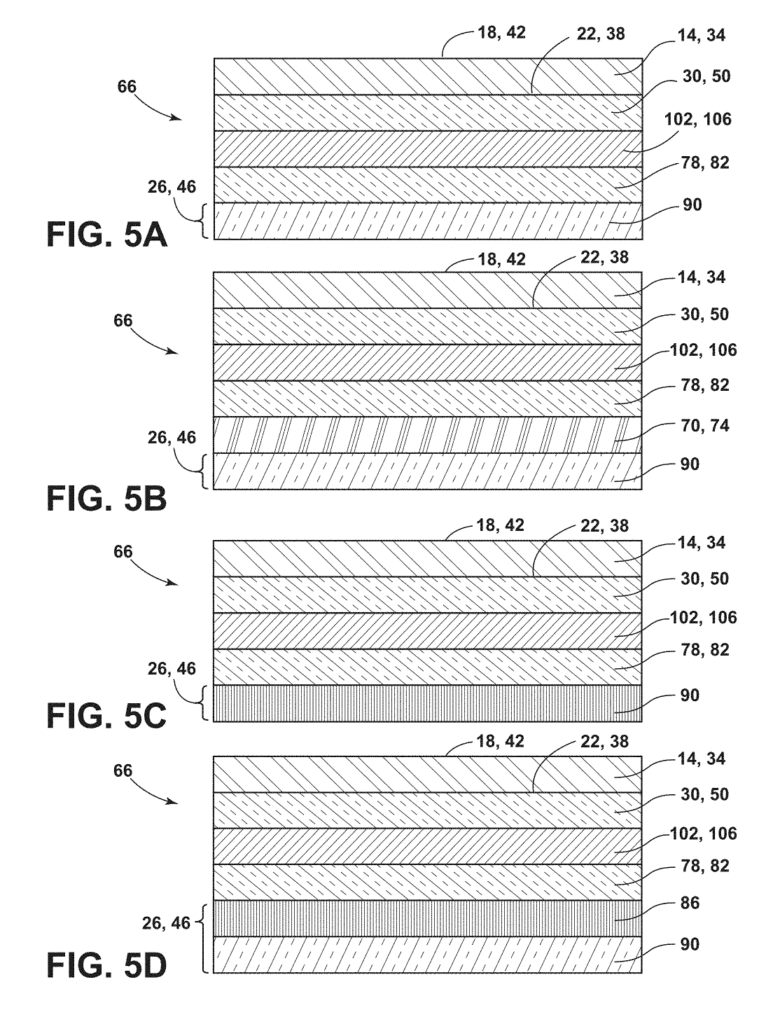

Referring to FIGS. 5A, 5C, and 5D, the substrate stack 66 includes the first substantially transparent substrate 14 defining the first and second surfaces 18, 22 where the second surface 22 comprises the first electrically conductive layer 26. The first hardcoat layer 30 is disposed between the first substrate 14 and the first conductive layer 26. The third hardcoat layer 78 is disposed between the first hardcoat layer 30 and the first conductive layer 26. A first metal layer 102 is disposed between the first hardcoat layer 30 and the third hardcoat layer 78. The conductive layer 26 may include a transparent conductive oxide (TCO) layer 90 as provided in FIGS. 5A and 5B, a silver (Ag) stack layer 86 as provided in FIG. 5C, or a combination conductive layer including the silver (Ag) stack layer 86 and the transparent conductive oxide (TCO) layer 90 stacked in any order. In some aspects, the first conductive layer 26 may include the silver (Ag) stack layer 86 positioned between the transparent conductive oxide (TCO) layer 90 and the third hardcoat layer 78, as illustrated in FIG. 5D. Referring to FIG. 5B, the first anti-reflective layer 70 can be disposed between the third hardcoat layer 78 and the first conductive layer 26. The first conductive layer 26 may include a transparent conductive oxide (TCO) layer 90, a silver (Ag) stack layer 86, or a combination thereof layered in any order. The first anti-reflective layer 70 can be used with any of the configurations of FIGS. 5A, 5C, and 5D.

The electro-optic element 10 incorporating the substrate stacks 66 illustrated in FIGS. 5A-5D may include: the first substantially transparent substrate 14 defining first and second surfaces 18, 22, where the second surface 22 includes the first electrically conductive layer 26; the first hardcoat layer 30 disposed between the first substrate 14 and the first conductive layer 26; the second substantially transparent substrate 34 defining third and fourth surfaces 38, 42, where the third surface 38 includes the second electrically conductive layer 46; the second hardcoat layer 50 disposed between the second substrate 34 and the second conductive layer 46; the sealing member 54 disposed between the first and second substrates 14, 34, wherein the sealing member 54 and the first and second substrates 14, 34 define the cavity 58 therebetween; the electrochromic medium 62 positioned in the cavity 58, where the electrochromic medium 62 comprises the cathodic and the anodic material; the third hardcoat layer 78 disposed between the first hardcoat layer 30 and the first conductive layer 26; and the fourth hardcoat layer 82 disposed between the second hardcoat layer 50 and the second conductive layer 46. The electro-optic element 10 using the substrate stack 66 of FIGS. 5A-5D additionally includes the first metal layer 102 disposed between the first hardcoat layer 30 and the third hardcoat layer 78 and a second metal layer 106 disposed between the second hardcoat layer 50 and the fourth hardcoat layer 82. The electro-optic element 10 using the substrate stack of FIG. 5B additionally includes the first antireflective layer 70 disposed between the third hardcoat layer 78 and the first conductive layer 26 in addition to the second antireflective layer 74 disposed between the fourth hardcoat layer 82 and the second conductive layer 46. The first and second anti-reflective layers 70 and 74 can be used with any of the configurations of FIGS. 5A, 5C, and 5D.

In another aspect, any of the above electro-optic elements 10 may further include an ultraviolet light-absorbing or reflecting film on the first substrate 14. Such a film may be included on the first surface 18 or the second surface 22 of the first substrate 14. An ultraviolet light-absorbing material may also be incorporated directly into the material (e.g., polymeric material) of the first substrate 14 itself when formed. Further, the electrochromic medium 62 may include an ultraviolet light-absorbing material to prevent, or at least minimize, degradation of the electrochromic medium 62 and polymeric examples of the second substrate 34 by ultraviolet light. For the purposes of this particular discussion with regard to the application of an ultraviolet light-absorbing film, the first substrate 14 is the substrate to be facing an ultraviolet light source. For example, if the electro-optic element 10 is incorporated into a window, the first substrate 14 is the substrate that will be exposed to the outside of the building or vehicle, and subject to incident light from the sun. Accordingly, the first surface 18 of the first substrate 14 may include the ultraviolet light-absorbing film. Alternatively, or in addition to, the second surface 22 of the first substrate 14 may include an ultraviolet light-absorbing material. Each of the first and second substrates 14, 34 itself may include an ultraviolet light-absorbing material.

Providing an ultraviolet light-absorbing material to the first and/or second substrates 14, 34 positioned somewhere in the disclosed substrate stacks 66 will provide for at least two advantages. The first advantage is related to preservation of the electrochromic medium 62. The electrochromic medium 62 may be sensitive to degradation by ultraviolet light. Accordingly, the ultraviolet-light-absorbing film may protect the electrochromic medium 62 from ultraviolet light exposure through the first substrate 14. The second advantage is to allow for the ability to UV-cure some of or all of the electrochromic medium 62 by UV light exposure through the second substrate 34 that has higher UV transmission. Electrochromic medium 62 may be gelled to prevent movement of the electrochromic medium 62 within the element 10, leakage from the element 10 in the event of breakage, or to provide a unitary structure by binding of the first substrate 14 to the second substrate 34. However, in many cases the electrochromic medium 62 includes dissolved ultraviolet light-absorbing species; therefore gels that are curable using ultraviolet light may, under some circumstances, not be employed. Use of an ultraviolet light-absorbing film on the first substrate 14 allows for the electrochromic medium 62 to include lesser amounts of ultraviolet light-absorbing species or no ultraviolet light-absorbing species while allowing for curing an ultraviolet light-curable gel as the electrochromic medium 62, as it may be activated by illuminating with ultraviolet light through the second substrate 34 for a time sufficient to produce a gel in the cavity 58. Materials that are used in the sealing member 54 at the perimeter of the electro-optic element 10 can also be UV cured in this manner.

Any of the materials used for the first and/or second substrates 14, 34 described herein may include a scratch-resistant coating on one or more surfaces (e.g., the first surface 18) to prevent, or at least minimize to the extent possible, damage to the outer surfaces of the electro-optic element 10. In some aspects, the first and/or fourth surfaces 18, 42 have a scratch-resistant coating. A gas diffusion barrier may be included on the second and/or third surfaces 22, 38 of the electro-optic element 10 such that polymeric examples of the first and second substrates 14, 34 provide a first barrier to water or gas incursion into the element 10. This first barrier may also provide solvent resistance and, alternatively, additional barrier or solvent resistance layers may be added. It is understood that the first and second polymeric substrates 14, 34 may comprise a multi-layer structure wherein the first water or oxygen barrier is located between two or more of the multi-layers. It is understood that the various layers described herein, which protect the first and second substrates 14, 34 from solvents, may also function well as diffusion barriers, as noted, to molecules such as water and oxygen. Depending on the requirements of a given application, the single or multi-layer coating stacks described herein may be further optimized to meet the requirements of diffusion barrier properties for multiple species. The water vapor transport rate (WVTR) may be less than about 0.1 g/m²/day, more preferably less than about 0.01 g/m²/day, or most preferably less than about 0.00001 g/m²/day, as measured at 50% relative humidity and 45° C. and/or at 90% relative humidity and 23° C. The oxygen transport rate (OTR) should be less than about 10 cm³/m²/day, more preferably less than about 0.1 cm³/m²/day, or most preferably less than about 0.0001 cm³/m²/day, as measured at 50% relative humidity and 45° C. and/or at 90% relative humidity and 23° C. Other coatings on any of the devices can include anti-fingerprint coatings, anti-fogging coatings, anti-smudge coatings and anti-reflection coatings.

In another aspect, any of the above electro-optic elements 10 may include ultraviolet light blocking structures to protect plastic films and/or the electrochromic medium 62. A glass top plate coated with a UV reflecting or absorbing coating can be adhered to the front (e.g., coupled with the first surface 18) or rear surface (e.g., coupled with the fourth surface 42) of the electro-optic element 10. A UV reflecting or absorbing film may be applied on the first surface 18 or the second surface 22 of the first substrate 14. Adhesive films such as pressure-sensitive adhesives (PSAs), laminating films such as polyvinyl butyl (PVB), ethylene vinyl acetate (EVA), or aliphatic thermoplastic urethane (TPU) contained within the electro-optic element 10 may contain UV-light-absorbing materials. An ultraviolet light-absorbing material may also be incorporated directly into polymeric examples of the first and/or second substrates 14, 34 when formed. As will be illustrated below, the electrochromic medium 62 may include an ultraviolet light-absorbing material to prevent, or at least minimize, degradation of the electrochromic medium 62 and first and/or second substrates 14, 34 by ultraviolet light. For the purposes of this particular discussion with regard to the application of an ultraviolet light-absorbing film, the first substrate 14 is the substrate to be facing an ultraviolet light source. For example, if the electro-optic element 10 is incorporated into a window of building or a vehicle, the first substrate 14 is the substrate that will be exposed to the outside of the building or vehicle, and subject to incident light from the sun. Accordingly, the first surface 18 of the first substrate 14 may include a glass top plate coated with UV reflecting or absorbing coating. An adhesive bonding which couples the glass top plate with the first surface 18 may also contain UV absorbing materials. Alternatively, or in addition to, the first surface 18 of the first substrate 14 may include an ultraviolet light reflecting or absorbing film. Alternatively, or in addition to, the second surface 22 of the first substrate 14 may include an ultraviolet light reflecting or absorbing film. Each substrate or adhesive within the electro-optic element 10 itself may include an ultraviolet light-absorbing material.

### EXAMPLES

Provided below are examples consistent with the present disclosure and comparative examples.

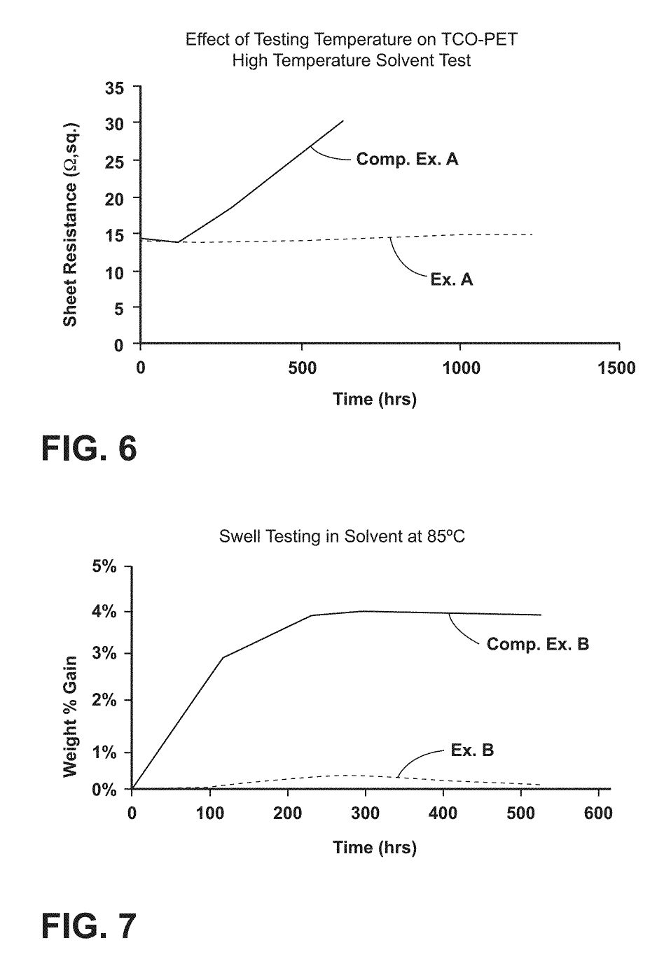

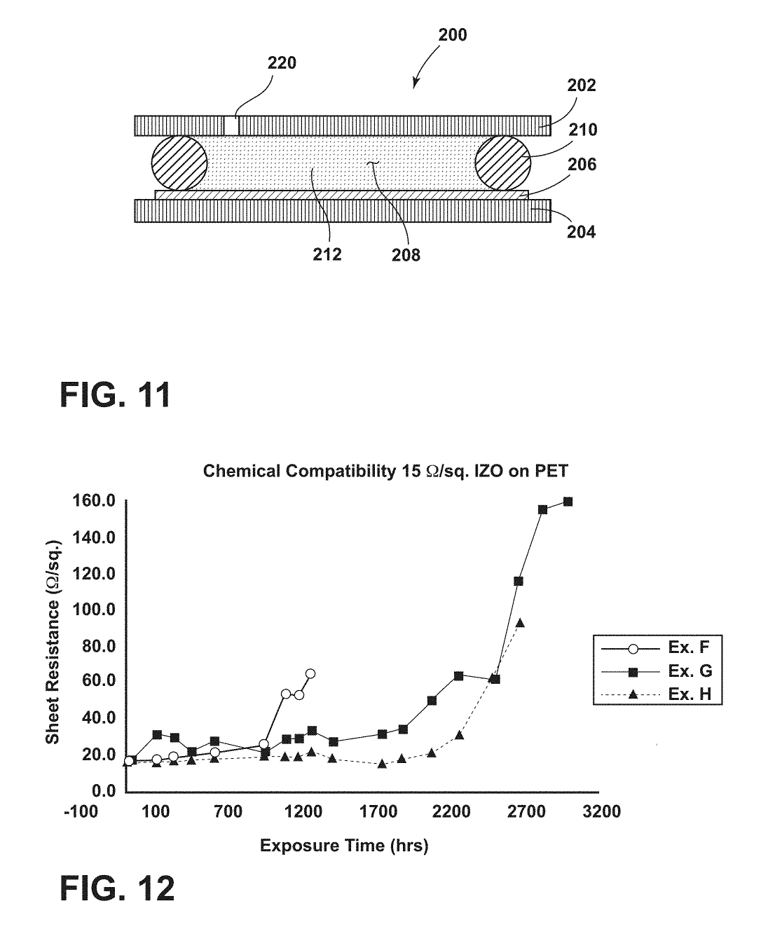

Referring now to FIG. 6, provided is graph showing the effect of temperature with respect to sheet resistance for a layer of indium tin oxide coated on polyethylene terephthalate (PET) when exposed to propylene carbonate at different temperatures. As can be seen, the sheet resistance is stable when the exposure temperature is low (45° C.) (“Example A”) but degrades with solvent exposure at elevated temperature (85° C.) (“Comparative Example A”). The “X” notes that the coating has degraded severely and no longer provides a continuous electrode for electrical conductivity. FIG. 11 shows a typical test cell 200 for electrical stability with solvent exposure and for solvent swelling tests. The test configuration includes two glass substrates 202, 204. One substrate 204 supports the test film 206 while the other substrate 202 provides a cover plate to form a chamber 208. A gasket 210 is placed between the two glass substrates 202, 204 creating the chamber 208 for the solvent 212 to be added via the fill port 220 in the top glass cover plate 202. This test configuration is then held at room temperature or put in an oven to be held at an elevated temperature. The test sample is periodically removed and its sheet resistance is measured. If the coating does not degrade with exposure to the solvent then the sheet resistance is stable with time. Conversely, if the sheet resistance increases, it is an indication that the transparent electrode layer is degrading and that the system is not stable at the evaluation temperature. Eventually, the degradation will reach a point where the transparent electrode no longer will conduct electricity and the test is ended. For other tests, the substrate, coated substrate and/or different variants as described in FIGS. 1, 2, 3A-3D, 4A-4D, and 5A-5D may be exposed to the solvent and the weight gain with time/temperature will be determined.

Referring now to FIG. 7, the effectiveness of a solvent resistant layer (i.e., one or a combination of the hardcoat layers 30, 50, 78, 82) may be quantified by the weight gain in a polymeric film (e.g., a polymeric film example of the first and/or second substrates 14, 34) during testing. Alternate methods may be employed as well. In one aspect, layers which minimize the weight gain of the polymeric film to below 1% are preferred. FIG. 7 shows the lower weight gain of a solvent resistant hardcoat coated polyethylene terephthalate film (“Example B”) of the present disclosure as compared to a polyethylene terephthalate film without a hardcoat (Comparative Example B) when exposed to propylene carbonate at 85° C. The sample of Example B was a PET substrate including an acrylic-based hardcoat commercially available under the tradename “Carestream Hardcoat” from Carestream.

While the weight change of the polymeric film is a good test for resistance of the coating to solvent, the presence of point defects on a solvent resistant coating can have detrimental effects. In some examples, the coating or hardcoat solvent resistant layer can show low weight gain, meeting the desired requirement for solvent resistant, but still develop defects. This occurs when there are point defects that caused blistering to develop in testing.

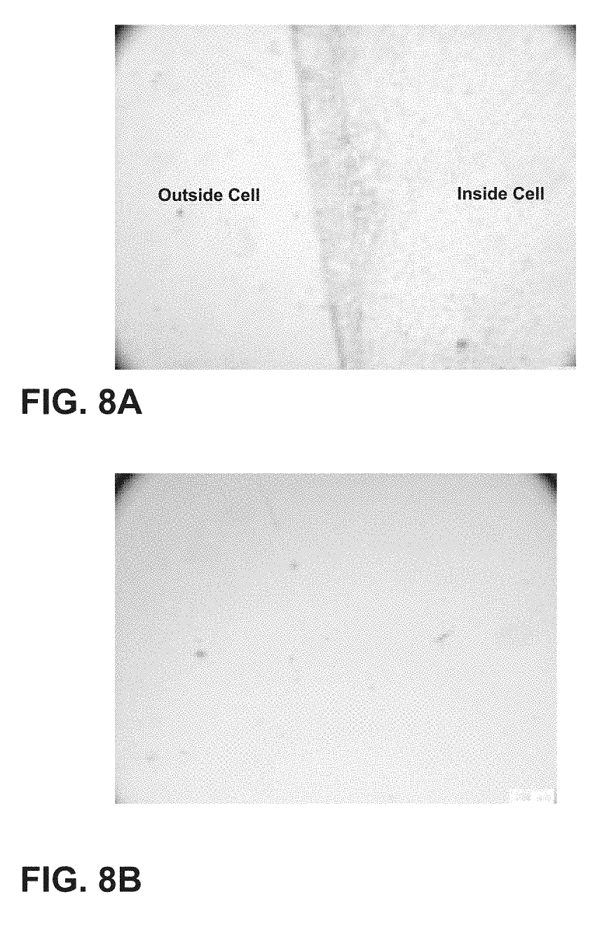

Referring now to FIGS. 8A and 8B, an acrylic-based hardcoated polymeric film (“Example C”) had a 0.5% weight gain over 500 hours of testing in solvent, but point defects caused blisters to form. The sample in Example C is an acrylic-based hardcoat commercially available from Carestream under the tradename “Carestream Super Hard.” FIG. 8A shows a zoomed-out view of the blisters that formed in the point defect in the testing area. FIG. 8B shows a zoomed-in view of the point defects. As can be seen, even though the coating system on plastic may be solvent resistant, it may still be necessary to minimize point defects in the film that may let solvent through which results in blistering and ultimately cracking. The weight gain of a polymer substrate, such as standard polyethylene terephthalate or polyethylene terephthalate/transparent conductive oxide film, is in the range of 4% for a 125 micron thick film. Preferably, the weight gain should be less than about 3%, less than about 2%, or less than about 1% for a 125 micron thick film. The percent change will scale with the thickness of the film. Films that maintained their sheet resistance in the high-temperature solvent test correlated to less weight gain during testing.

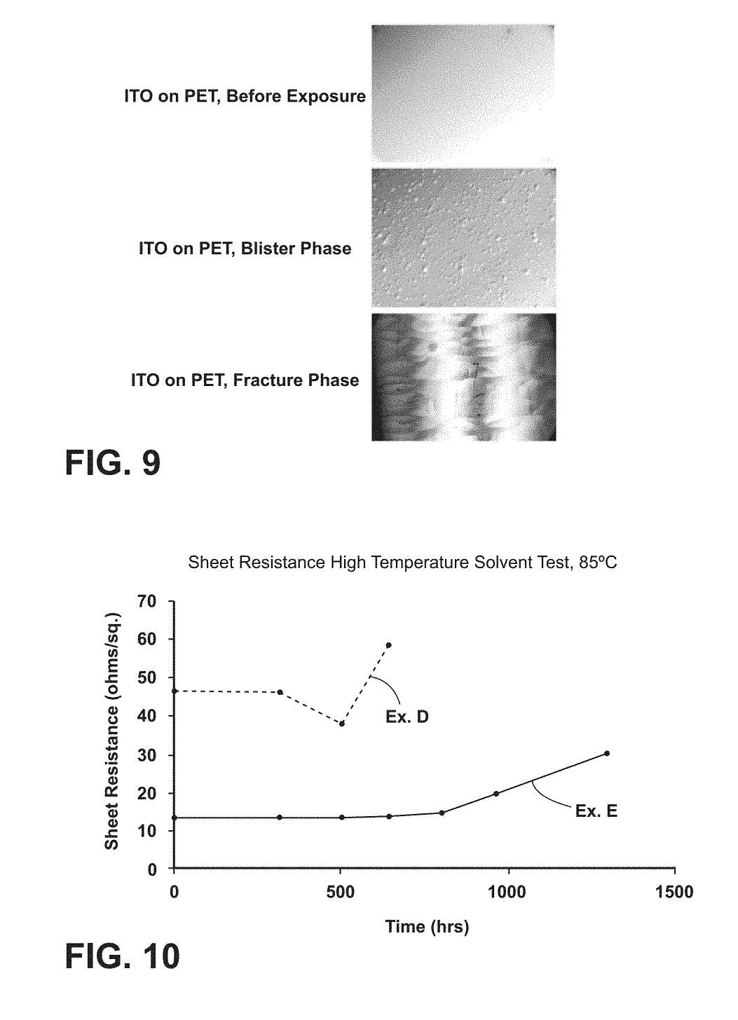

Referring now to FIG. 9, shown are the failure modes observed in a transparent conductive oxide polyethylene terephthalate (PET) system (“Comparative Example C”) with the exposure to solvent at elevated temperatures. The initial defect that formed was blisters, which did not affect the sheet resistance immediately. This blister phase was followed by a fracture phase as the blister defects combine and develop within the structure leading to lack of continuity and thus increased sheet resistance and eventual loss of conductivity. This limits the lifetime and applicable applications for a polymer substrate-based electro-optic device. It is theorized that the point defects in the substrate or hard coated substrate may act as nucleation sites for the initial blisters. Alternatively, the blisters may be initiated by debris on the surface prior to the coating of the transparent electrode layer, i.e., TCO, Ag, or IMI structure as described above.

Referring now to FIG. 10, provided is a graph of sheet resistance change with testing for two different sheet resistance transparent conductive oxides on polyethylene terephthalate. The 50 ohm/sq example is indium tin oxide on polyethylene terephthalate (“Example D”, while the 15 ohm/sq is indium zinc oxide on polyethylene terephthalate (“Example E”). The IZO layer is thicker than the ITO layer. Typically, IZO is also amorphous while ITO may have microcrystallinity. The microcrystallinity of the ITO may provide pathways for solvents as described above which may contribute to the faster time to failure for these films. In some embodiments, the TCO, or IMI, electrode will include layers or sub-layers which are amorphous to minimize solvent diffusion pathways. In some embodiments, it may be preferred that the TCO or layers within the IMI structure are amorphous.

The high-temperature solvent test was the test used to evaluate the degradation of the films in solvent at elevated temperatures. The standard test conditions were at 85° C. in propylene carbonate solvent. Other solvents tested include but are not limited to 1,2-propanediol, gamma butyrolactone, ethylene carbonate, propylene glycol, glutaronitrile, tetraglyme, glycerine carbonate, tributylmethylammonium dibutyl phosphate, water and triethylenesulfonium bis (trifluoroborate) imide. The samples were tested using the setup described above in FIG. 11. This entire cell was placed in the oven at the desired temperature and time period. Images, sheet resistance, or weight change in the film were measured at regular intervals after draining the solvent and drying the films. After each measurement, the cells were re-assembled along with the addition of solvent and reintroduced to the desired temperature. FIG. 12 shows the stability of an IZO film on PET when exposed to different solvents. Propylene Carbonate (“Example F”), Tetraglyme (Example G”), and Propylene Glycol (Example H”) were evaluated. The stability, or time to failure, of the IZO transparent electrode varied with the different solvents, but all of the solvents demonstrated a failure mode after the last time point indicated in the plot. The solvent stability of the electrodes could be improved with a change in solvent thus potentially enabling a workable solution for different applications.

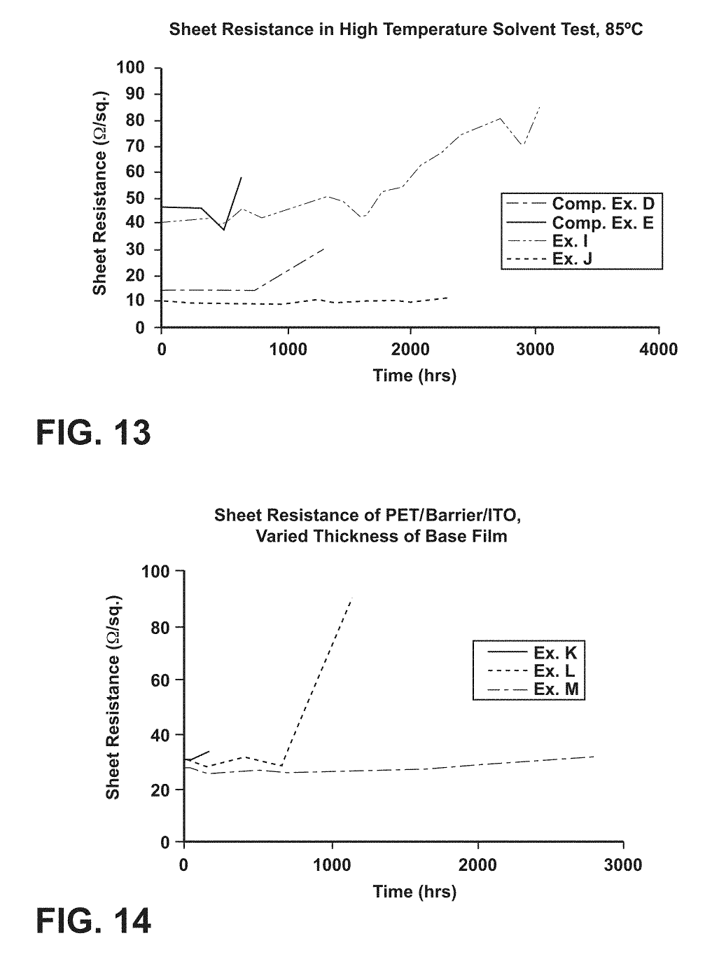

Referring now to FIG. 13, provided is the change in sheet resistance example materials on polyethylene terephthalate (PET). Comparative Example D is an indium zinc oxide layer having a sheet resistance of 15 ohm/sq deposited on a polyethylene terephthalate (PET) film. Comparative Example E is an indium tin oxide (ITO) layer having a sheet resistance of 50 ohm/sq on a PET film. Example I includes a commercially available polymer multi-layer product (PML) disposed between a PET film and an ITO conductive layer having a sheet resistance of 40 ohm/sq. The PML in Example J is a flexible transparent barrier film sold by 3M under the trade name FTB3-125 Barrier Film, and is described by 3M as a PET substrate with two vacuum deposited acrylic polymer layers with an inorganic oxide layer positioned between the two polymer layers. Example J includes a silver-based IMI stack commercially available from TDK Corporation on a hard coated PET substrate with an additional indium tin oxide layer added on top to provide electrical conductivity to the fluid. The stability of the sheet resistance for each example at 85° C. should be maintained for about 500 hours, 1000 hours, 1500 hours, or up to or exceeding 2000 hours. The data in FIG. 13 for Example I using the ITO coated PML product and for Example J using the ITO coated silver-based IMI stack demonstrate that the PET substrate can be modified to increase the solvent resistance of ITO or IMI at elevated temperatures. No further measurements were obtained for Comparative Example D and E after the last data point illustrated in the plot due to failure of the test device.

Referring now to FIG. 14, the sheet resistance stability of a substrate stack including the 3M FTB3 Barrier Film is illustrated for different substrate film thicknesses. Each measured sample includes a PET film substrate, an ITO conductive layer, a polycarbonate solvent, and a 3M FTB3Barrier Film layer between the PET film substrate and the ITO conductive layer. Examples K, L, and M are the same except for a difference in the thickness of the base film substrate: 50 microns (Example K), 125 microns (Example L), and 270 microns (Example M). Examples K and L both include a PET substrate. Example M includes a 125 micron base substrate with an additional PET layer laminated on a backside of the base substrate for a total substrate thickness of 270 microns, which is commercially available under the tradename BPS-270 from 3M. As demonstrated in FIG. 14, the stability of the sheet resistance tracks with the thickness of the base film substrate with the thicker substrates demonstrating superior sheet resistance stability. This demonstrates the improved stability which comes with the rigidity of the thicker substrate as described above. No further measurements were obtained for Examples K and L after the last data point illustrated in the plot due to failure of the test device.

Referring now to FIG. 15, the solvent resistance performance of an indium tin oxide (ITO) coated polymer multi-layer (PML) structure (3M's FTB3-125) is contrasted with a “free” film state in which the film is not constrained during deposition of the ITO layer. Example N includes an ITO layer that is coated onto a PML structure after the PML structure has been laminated onto a glass substrate. Example O includes a PML structure that is coated with an ITO layer prior to laminating the PML structure onto a glass substrate. In this example, the rigid substrate is a 1.6 mm thick piece of soda lime float glass. Example P is the “free” film in which the ITO is deposited on the PML structure, but is not laminated to rigid substrate. The solvent in each of the examples is polycarbonate. The “free” film performs well with sheet resistance stability out to about 600 hours but the laminated films are still performing well after 2800 hours of high-temperature solvent exposure. This is further support for the improved stability which comes with the rigidity of the substrate. It will be understood that the rigidity may be imparted before or after the deposition of the transparent electrodes. Therefore, in an application where the film based EC is subsequently laminated to a substrate as part of a device architecture, the supported film is expected to have improved stability compared to the unsupported film. No further measurements were obtained for Example P after the last data point illustrated in the plot due to failure of the test device.

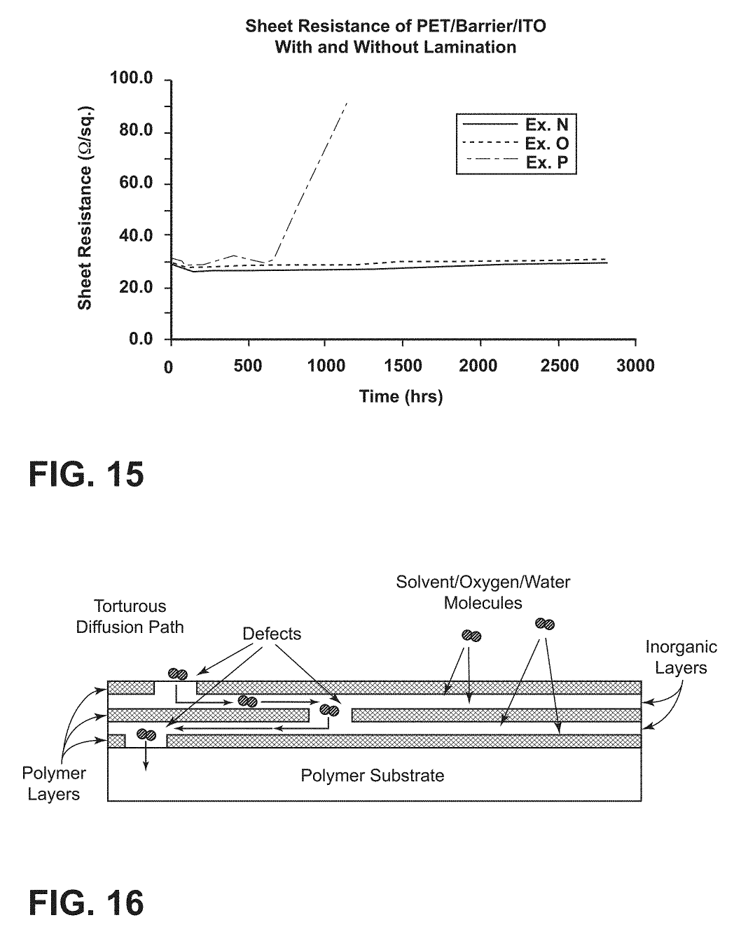

Referring now to FIG. 16, provided is a schematic diagram of a tortuous path formed from the layering of inorganic layers and polymeric layers in the substrate stack 66 according to the present disclosure. The schematic provided in FIG. 16 is shown for the purposes of discussion only and is not intended to limit the scope of the present disclosure in any way or to imply that this is the only mechanism by which the aspects of the present disclosure operate. As explained above, the layering of the polymer and inorganic components creates longer pathways through which water, oxygen, and solvent molecules have to pass through. By increasing the length of the pathways, the time it takes for water, oxygen, and/or solvent molecules to reach a polymeric substrate (e.g., the first and/or second substrates 14, 34) may be increased. The PML structure defined above is a method for creating this architecture. As noted above, the PML structure may have multiple additional inorganic/polymer layers as needed to achieve the desired barrier performance.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structure without departing from the concepts of the present invention, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

### List of Non-Limiting Embodiments

Embodiment A is an electro-optic element including: a first substantially transparent substrate defining first and second surfaces, wherein the second surface includes a first electrically conductive layer; a first hardcoat layer disposed between the first substrate and the first conductive layer; a second substantially transparent substrate defining third and fourth surfaces, wherein the third surface includes a second electrically conductive layer; a second hardcoat layer disposed between the second substrate and the second conductive layer; a sealing member disposed between the first and second substrates, wherein the sealing member and the first and second substrates define a cavity therebetween; and an electrochromic medium positioned in the cavity, where the electrochromic medium includes a cathodic and an anodic material.

The electro-optic element of Embodiment A further including a first antireflective layer disposed between the first hardcoat layer and the first conductive layer; and a second antireflective layer disposed between the second hardcoat layer and the second conductive layer.

The electro-optic element of Embodiment A or Embodiment A with any of the intervening features further including a third hardcoat layer disposed between the first hardcoat layer and the first conductive layer; and a fourth hardcoat layer disposed between the second hardcoat layer and the second conductive layer.

The electro-optic element of Embodiment A or Embodiment A with any of the intervening features further including a first antireflective layer disposed between the third hardcoat layer and the first conductive layer; and a second antireflective layer disposed between the fourth hardcoat layer and the second conductive layer.

The electro-optic element of Embodiment A or Embodiment A with any of the intervening features wherein the first and second conductive layers comprise an indium tin oxide (ITO) layer, a silver (Ag) stack layer, or a combination thereof layered in any order.

The electro-optic element of Embodiment A or Embodiment A with any of the intervening features wherein the first substrate, the second substrate, or both the first and second substrates independently comprise polyethylene naphthalate (PEN), polyacrylonitrile, polyethylene terephthalate (PET), polycarbonate, a cycloolefin polymer (COP), a cycloolefin co-polymer (COC), an acrylic, a polyamide, an epoxy, or a blended combination thereof.

The electro-optic element of Embodiment A or Embodiment A with any of the intervening features wherein the cathodic material includes a viologen and the anodic material includes phenazine, a carbazole, an indolocarbazole, a biscarbazole, a ferrocene, or a combination thereof.

Embodiment B is an electro-optic element including: a first substantially transparent substrate defining first and second surfaces, wherein the second surface includes a first electrically conductive layer; a first hardcoat layer disposed between the first substrate and the first conductive layer; a second substantially transparent substrate defining third and fourth surfaces, wherein the third surface includes a second electrically conductive layer; a second hardcoat layer disposed between the second substrate and the second conductive layer; a sealing member disposed between the first and second substrates, wherein the sealing member and the first and second substrates define a cavity therebetween; an electrochromic medium positioned in the cavity, where the electrochromic medium includes a cathodic and an anodic material; a third hardcoat layer disposed between the first hardcoat layer and the first conductive layer; and a fourth hardcoat layer disposed between the second hardcoat layer and the second conductive layer.

The electro-optic element of Embodiment B further including a first inorganic oxide layer disposed between the first hardcoat layer and the third hardcoat layer; and a second inorganic oxide layer disposed between the second hardcoat layer and the fourth hardcoat layer.

The electro-optic element of Embodiment B or Embodiment B with any of the intervening features further including a first antireflective layer disposed between the third hardcoat layer and the first conductive layer; and a second antireflective layer disposed between the fourth hardcoat layer and the second conductive layer.

The electro-optic element of Embodiment B or Embodiment B with any of the intervening features wherein the first and second conductive layers comprise an indium tin oxide (ITO) layer, a silver (Ag) stack layer, or a combination thereof layered in any order.

The electro-optic element of Embodiment B or Embodiment B with any of the intervening features wherein the first substrate, the second substrate, or both the first and second substrates independently comprise polyethylene naphthalate (PEN), polyacrylonitrile, polyethylene terephthalate (PET), polycarbonate, a cycloolefin polymer (COP), a cycloolefin co-polymer (COC), an acrylic, a polyamide, an epoxy, or a blended combination thereof.

The electro-optic element of Embodiment B or Embodiment B with any of the intervening features wherein the electrochromic medium includes a cathodic material and an anodic material.

The electro-optic element of Embodiment B or Embodiment B with any of the intervening features wherein the cathodic material includes a viologen and the anodic material includes phenazine, a carbazole, an indolocarbazole, a biscarbazole, a ferrocene, or a combination thereof.

Embodiment C is an electro-optic element including: a first substantially transparent substrate defining first and second surfaces, wherein the second surface includes a first electrically conductive layer; a first hardcoat layer disposed between the first substrate and the first conductive layer; a second substantially transparent substrate defining third and fourth surfaces, wherein the third surface includes a second electrically conductive layer; a second hardcoat layer disposed between the second substrate and the second conductive layer; a sealing member disposed between the first and second substrates, wherein the sealing member and the first and second substrates define a cavity therebetween; an electrochromic medium positioned in the cavity, where the electrochromic medium includes a cathodic and an anodic material; a third hardcoat layer disposed between the first hardcoat layer and the first conductive layer; and a fourth hardcoat layer disposed between the second hardcoat layer and the second conductive layer.

The electro-optic element of Embodiment C further including a first metal layer disposed between the first hardcoat layer and the third hardcoat layer; and a second metal layer disposed between the second hardcoat layer and the fourth hardcoat layer.

The electro-optic element of Embodiment C or Embodiment C with any of the intervening features further including a first antireflective layer disposed between the third hardcoat layer and the first conductive layer; and a second antireflective layer disposed between the fourth hardcoat layer and the second conductive layer.

The electro-optic element of Embodiment C or Embodiment C with any of the intervening features wherein the first and second conductive layers comprise an indium tin oxide (ITO) layer, a silver (Ag) stack layer, or a combination thereof layered in any order.

The electro-optic element of Embodiment C or Embodiment C with any of the intervening features wherein the first substrate, the second substrate, or both the first and second substrates independently comprise polyethylene naphthalate (PEN), polyacrylonitrile, polyethylene terephthalate (PET), polycarbonate, a cycloolefin polymer (COP), a cycloolefin co-polymer (COC), an acrylic, a polyamide, an epoxy, or a blended combination thereof.

The electro-optic element of Embodiment C or Embodiment C with any of the intervening features wherein the electrochromic medium includes a cathodic material and an anodic material, and wherein the cathodic material includes a viologen and the anodic material includes phenazine, a carbazole, an indolocarbazole, a biscarbazole, a ferrocene, or a combination thereof.

Embodiment D is an electro-optic element that includes a substantially transparent polymer substrate, a first polymer multi-layer film, and a second substantially transparent substrate. The first substantially transparent polymer substrate defines first and second surfaces, wherein the second surface comprises a first electrically conductive layer. The first polymer multi-layer film is disposed between the first substrate and the first conductive layer and includes a first polymer layer, an inorganic layer, and a second polymer layer. The second substantially transparent substrate defines a third surface and a fourth surface, wherein the third surface comprises a second electrically conductive layer. An electrochromic medium is positioned in a cavity defined between the first and second substrates, wherein the electrochromic medium comprises a cathodic material, an anodic material, and at least one solvent.

The electro-optic element of Embodiment D, wherein the first polymer layer is characterized by a thickness of about 2 nanometers to about 10 micrometers, the inorganic layer is characterized by a thickness of about 3 nanometers to about 150 nanometers, and the second polymer layer is characterized by a thickness of about 2 nanometers to about 10 micrometers.

The electro-optic element of Embodiment D or Embodiment D in combination with any of the intervening features, wherein at least one of the first polymer layer, the inorganic layer, and the second polymer layer is deposited in a vacuum deposition process.

The electro-optic element of Embodiment D or Embodiment D in combination with any of the intervening features, wherein the first polymer layer and the second polymer layer includes an acrylic polymer layer and the inorganic layer includes an inorganic oxide.

The electro-optic element of Embodiment D or Embodiment D in combination with any of the intervening features, wherein a thickness of at least one of the first and second substantially transparent polymer substrates is about 50 micrometers or greater.

The electro-optic element of Embodiment D or Embodiment D in combination with any of the intervening features, wherein a thickness of at least one of the first and second substantially transparent polymer substrates is about 125 micrometers or greater.

The electro-optic element of Embodiment D or Embodiment D in combination with any of the intervening features, wherein a thickness of at least one of the first and second substantially transparent polymer substrates is about 200 micrometers or greater.

The electro-optic element of Embodiment D or Embodiment D in combination with any of the intervening features, wherein the first substantially transparent polymer substrate is characterized by at least one of a thickness that provides a surface stress of less than about 4×10⁴ psi, as measured on a 1 inch long and 0.1 inch wide sample with a 0.01 psi applied force and a deflection of less than about 8 inches under a 0.01 psi applied force, as measured on a 1 inch long and a 0.1 inch wide sample, at least one of prior to or subsequent to disposing the first polymer multi-layer film on the first substantially transparent polymer substrate.

The electro-optic element of Embodiment D or Embodiment D in combination with any of the intervening features, further including a third substrate one of coupled with or laminated to the first substantially transparent polymer substrate, wherein the third substrate is characterized by a higher rigidity than a rigidity of the first substantially transparent substrate.

The electro-optic element of Embodiment D or Embodiment D in combination with any of the intervening features, wherein at least one of the first substantially transparent polymer substrate and the second substantially transparent polymer substrate includes at least one of polyethylene, low density polyethylene, high density polyethylene, polyethylene naphthalate (PEN), polyacrylonitrile, polyethylene terephthalate (PET), heat-stabilized PET, polycarbonate, polysulfone, poly(methyl methacrylate) (PMMA)), polyimides, a cyclic olefin polymer (COP), a cyclic olefin co-polymer (COC), an acrylic, a polyamide, a cycloaliphatic diamine dodecanedioic acid polymer, an epoxy, polymethylpentene, cellulose ester-based plastics, cellulose triacetate, a transparent fluoropolymer, polyacrylonitrile, and a combination thereof.

The electro-optic element of Embodiment D or Embodiment D in combination with any of the intervening features, wherein at least one of the first and second substantially transparent polymer substrates include a Young's Modulus of about 3×10⁵ psi to about 8×10⁵ psi.

The electro-optic element of Embodiment D or Embodiment D in combination with any of the intervening features, wherein at least one of the first and second substantially transparent polymer substrates include a Young's Modulus of about 3×10⁵ psi or greater.

The electro-optic element of Embodiment D or Embodiment D in combination with any of the intervening features, wherein at least one of the first and second substantially transparent polymer substrates include a Young's Modulus of about 5×10⁵ psi or greater.

The electro-optic element of Embodiment D or Embodiment D in combination with any of the intervening features, wherein at least one of the first and second substantially transparent polymer substrates include a Young's Modulus of about 6×10⁵ psi or greater.

The electro-optic element of Embodiment D or Embodiment D in combination with any of the intervening features, wherein the inorganic layer includes an aluminum oxide.

The electro-optic element of Embodiment D or Embodiment D in combination with any of the intervening features, wherein the inorganic layer includes an amorphous structure.

The electro-optic element of Embodiment D or Embodiment D in combination with any of the intervening features, at least one of the first polymer layer and the second polymer layer includes at least one of an acrylic polymer, a siloxane-based polymer, a polyethylene terephthalate (PET) polymer, a polyester polymer, poly(methyl methacrylate) (PMMA), a polycarbonate (PC) polymer, and a combination thereof. The inorganic layer includes at least one of silicon oxide, silicon nitride, zinc tin oxide, aluminum oxide, tin oxide, hafnium oxide, and combinations thereof.

The electro-optic element of Embodiment D or Embodiment D in combination with any of the intervening features, further including a second polymer multi-layer film disposed between the second substantially transparent polymer substrate and the second conductive layer.

The electro-optic element of Embodiment D or Embodiment D in combination with any of the intervening features, wherein the first electrically conductive layer is characterized by a change in sheet resistance of less than 20% after exposure to the electrochromic medium at an electrochromic medium temperature of 45° C. for 1000 hours.

The electro-optic element of Embodiment D or Embodiment D in combination with any of the intervening features, wherein the first polymer multi-layer film is configured to resist solvent penetration.

The electro-optic element of Embodiment D or Embodiment D in combination with any of the intervening features, wherein at least one of the first and second substrates is flexible.

The electro-optic element of Embodiment D or Embodiment D in combination with any of the intervening features, wherein at least one of the first and second substrates includes polyethylene terephthalate.

The electro-optic element of Embodiment D or Embodiment D in combination with any of the intervening features, wherein at least one of the first and second conductive layers is transparent.

The electro-optic element of Embodiment D or Embodiment D in combination with any of the intervening features, wherein at least one of the first and second conductive layers includes a transparent conductive oxide.

The electro-optic element of Embodiment D or Embodiment D in combination with any of the intervening features, wherein at least one of the first and second conductive layers includes indium tin oxide.

The electro-optic element of Embodiment D or Embodiment D in combination with any intervening features, wherein at least one of the first and second conductive layers includes a sheet resistance of 50 ohms/square or less.

The electro-optic element of Embodiment D or Embodiment D in combination with any intervening features, wherein at least one of the first and second conductive layers includes a sheet resistance of 20 ohms/square or less.

The electro-optic element of Embodiment D or Embodiment D in combination with any intervening features, wherein at least one of the first and second conductive layers comprises indium zinc oxide.

The electro-optic element of Embodiment D or Embodiment D in combination with any intervening features, wherein the cathodic material includes a viologen and the anodic material includes at least one of a phenazine, a carbazole, an indolocarbazole, a biscarbazole, a ferrocene, and a combination thereof.

The electro-optic element of Embodiment D or Embodiment D in combination with any intervening features, further including a sealing member disposed between the first and second substrates, wherein the sealing member and the first and second substrates at least partially define the cavity therebetween.

The electro-optic element of Embodiment D or Embodiment D in combination with any intervening features, further comprising a first anti-reflective layer disposed between the first polymer multi-layer film and the first electrically conductive layer.

Embodiment E is an electro-optic element that includes a first substantially transparent polymer substrate, a first hardcoat layer, a second substantially transparent polymer substrate, a second hardcoat layer, and an electrochromic medium. The first substantially transparent polymer substrate defines first and second surfaces, wherein the second surface includes a first electrically conductive layer. The first hardcoat layer is disposed between the first substrate and the first electrically conductive layer. The second substantially transparent polymer substrate defines third and fourth surfaces, wherein the third surface includes a second electrically conductive layer. The second hardcoat layer is disposed between the second substrate and the second electrically conductive layer. The electrochromic medium is disposed in a cavity defined between the first and second substrates and includes a cathodic material, an anodic material, and at least one solvent. The first and second electrically conductive layers are characterized by a change in sheet resistance of less than 20% after exposure to the electrochromic medium at an electrochromic medium temperature of 45° C. for 1000 hours.

The electro-optic element of Embodiment E, wherein the first and second electrically conductive layers are characterized by a change in sheet resistance of less than 20% after exposure to the electrochromic medium at an electrochromic medium temperature of greater than 45° C. to about 85° C. for 1000 hours.

The electro-optic element of Embodiment E or Embodiment E in combination with any intervening features, wherein at least one of the first and second electrically conductive layers is transparent.

The electro-optic element of Embodiment E or Embodiment E in combination with any intervening features, wherein at least one of the first and second electrically conductive layers includes at least one of fluorine-doped tin oxide, aluminum zinc oxide (AZO), indium zinc oxide (IZO), and indium tin oxide (ITO).

The electro-optic element of Embodiment E or Embodiment E in combination with any intervening features, wherein at least one of the first hardcoat layer and the second hardcoat layer includes at least one of an acrylic polymer, a siloxane-based polymer, a polyethylene terephthalate (PET) polymer, a polyester polymer, poly(methyl methacrylate) (PMMA), a polycarbonate (PC) polymer, and a combination thereof.

The electro-optic element of Embodiment E or Embodiment E in combination with any intervening features, wherein at least one of the first and second electrically conductive layers comprises an insulator-metal-insulator structure.

The electro-optic element of Embodiment E or Embodiment E in combination with any intervening features, wherein the insulator-metal-insulator structure comprises a silver metal, a silver metal alloy, or a doped silver layer.

The electro-optic element of Embodiment E or Embodiment E in combination with any intervening features, further including a third hardcoat layer disposed between the first hardcoat layer and the first electrically conductive layer. A fourth hardcoat layer is disposed between the second hardcoat layer and the second electrically conductive layer.

The electro-optic element of Embodiment E or Embodiment E in combination with any intervening features, further including a first inorganic layer disposed between the first hardcoat layer and the third hardcoat layer. A second inorganic layer is disposed between the second hardcoat layer and the fourth hardcoat layer.

The electro-optic element of Embodiment E or Embodiment E in combination with any intervening features, wherein at least one of the first and second hardcoat layers includes a Shore D hardness of about 50 to about 100.

The electro-optic element of Embodiment E or Embodiment E in combination with any intervening features, wherein at least one of the first and second hardcoat layers includes a Shore D hardness of at least 50.

The electro-optic element of Embodiment E or Embodiment E in combination with any intervening features, wherein at least one of the first and second hardcoat layers includes a Shore D hardness of at least 60.

The electro-optic element of Embodiment E or Embodiment E in combination with any intervening features, wherein at least one of the first and second hardcoat layers includes a Shore D hardness of at least 70.

The electro-optic element of Embodiment E or Embodiment E in combination with any intervening features, wherein at least one of the first and second hardcoat layers includes a Shore D hardness of at least 80.

The electro-optic element of Embodiment E or Embodiment E in combination with any intervening features, wherein at least one of the first substantially transparent polymer substrate and the second substantially transparent polymer substrate includes at least one of polyethylene, low density polyethylene, high density polyethylene, polyethylene naphthalate (PEN), polyacrylonitrile, polyethylene terephthalate (PET), heat-stabilized PET, polycarbonate, polysulfone, poly(methyl methacrylate) (PMMA)), polyimides, a cyclic olefin polymer (COP), a cyclic olefin co-polymer (COC), an acrylic, a polyamide, a cycloaliphatic diamine dodecanedioic acid polymer, an epoxy, polymethylpentene, cellulose ester-based plastics, cellulose triacetate, a transparent fluoropolymer, polyacrylonitrile, and a combination thereof.

The electro-optic element of Embodiment E or Embodiment E in combination with any intervening features, wherein at least one of the first and second substantially transparent polymer substrates includes at least one of: a thickness that provides a surface stress of less than about 4×10⁴ psi, as measured on a 1 inch long and 0.1 inch wide sample with a 0.01 psi applied force and a deflection of less than about 8 inches under a 0.01 psi, as measured on a 1 inch long and a 0.1 inch wide sample, at least one of prior to or subsequent to disposing one of the first and second hardcoat layers on the respective one of the first and second substantially transparent polymer substrates.

The electro-optic element of Embodiment E or Embodiment E in combination with any intervening features, further comprising at least one of a third substrate one of coupled with or laminated to the first substantially transparent polymer substrate, wherein the third substrate is characterized by a higher rigidity than a rigidity of the first substantially transparent substrate and a fourth substrate one of coupled with or laminated to the second substantially transparent polymer substrate, wherein the fourth substrate is characterized by a higher rigidity than a rigidity of the second substantially transparent substrate.

The electro-optic element of Embodiment E or Embodiment E in combination with any intervening features, wherein at least one of the first and second hardcoat layers includes a thickness of about 0.1 micrometers to about 100 micrometers.

The electro-optic element of Embodiment E or Embodiment E in combination with any intervening features, wherein at least one of the first and second hardcoat layers includes a thickness of about 0.3 micrometers to about 100 micrometers.

The electro-optic element of Embodiment E or Embodiment E in combination with any intervening features, wherein at least one of the first and second hardcoat layers includes a thickness of about 5 micrometers to about 20 micrometers.

The electro-optic element of Embodiment E or Embodiment E in combination with any intervening features, wherein at least one of the first and second hardcoat layers includes a thickness of about 10 micrometers to about 15 micrometers.

The electro-optic element of Embodiment E or Embodiment E in combination with any intervening features, wherein the cathodic material includes a viologen and the anodic material includes at least one of a phenazine, a carbazole, an indolocarbazole, a biscarbazole, a ferrocene, and a combination thereof.

The electro-optic element of Embodiment E or Embodiment E in combination with any intervening features, wherein at least one of the first and second conductive layers includes a transparent conductive oxide.

The electro-optic element of Embodiment E or Embodiment E in combination with any intervening features, wherein at least one of the first and second conductive layers includes an indium tin oxide.

The electro-optic element of Embodiment E or Embodiment E in combination with any intervening features, wherein at least one of the first and second conductive layers includes a sheet resistance of 50 ohms/square or less.

The electro-optic element of Embodiment E or Embodiment E in combination with any intervening features, wherein at least one of the first and second conductive layers includes a sheet resistance of 20 ohms/square or less.

The electro-optic element of Embodiment E or Embodiment E in combination with any intervening features, wherein at least one of the first and second conductive layers comprises indium zinc oxide.

The electro-optic element of Embodiment E or Embodiment E in combination with any intervening features, wherein at least one of the first and second substrates is flexible.

The electro-optic element of Embodiment E or Embodiment E in combination with any intervening features, wherein at least one of the first and second substrates has a thickness of 50 micrometers or greater.

The electro-optic element of Embodiment E or Embodiment E in combination with any intervening features, wherein at least one of the first and second substrates has a thickness of 125 micrometers or greater.

The electro-optic element of Embodiment E or Embodiment E in combination with any intervening features, wherein at least one of the first and second substrates has a thickness of 200 micrometers or greater.

The electro-optic element of Embodiment E or Embodiment E in combination with any intervening features, wherein at least one of the first and second substrates includes polyethylene terephthalate.

The electro-optic element of Embodiment E or Embodiment E in combination with any intervening features, wherein at least one of the first and second substantially transparent polymer substrates include a Young's Modulus of about 3×10⁵ psi or greater.

The electro-optic element of Embodiment E or Embodiment E in combination with any intervening features, wherein at least one of the first and second substantially transparent polymer substrates include a Young's Modulus of about 5×10⁵ psi or greater.

The electro-optic element of Embodiment E or Embodiment E in combination with any intervening features, wherein at least one of the first and second substantially transparent polymer substrates include a Young's Modulus of about 6×10⁵ psi or greater.

The electro-optic element of Embodiment E or Embodiment E in combination with any intervening features, wherein the inorganic layer includes an aluminum oxide.

The electro-optic element of Embodiment E or Embodiment E in combination with any intervening features, wherein the inorganic layer includes an amorphous structure.

The electro-optic element of Embodiment E or Embodiment E in combination with any intervening features, wherein at least one of the first hardcoat layer and the second hardcoat layer includes an acrylic polymer.

The electro-optic element of Embodiment E or Embodiment E in combination with any intervening features, further including a sealing member disposed between the first and second substrates, wherein the sealing member and the first and second substrates at least partially define the cavity therebetween.

The electro-optic element of Embodiment E or Embodiment E in combination with any intervening features, further comprising a first anti-reflective layer disposed between the first hardcoat layer and the first conductive layer and a second anti-reflective layer disposed between the second hardcoat layer and the second conductive layer.

What is claimed is:

1. An electro-optic element, comprising:
a first substantially transparent polymer substrate defining first and second surfaces, wherein the second surface comprises a first electrically conductive layer;
a first polymer multi-layer film disposed between the first substrate and the first conductive layer, wherein the first polymer multi-layer film comprises:
a first polymer layer;
an inorganic layer; and
a second polymer layer;
a second substantially transparent substrate defining a third surface and a fourth surface, wherein the third surface comprises a second electrically conductive layer; and
an electrochromic medium positioned in a cavity defined between the first and second substrates, wherein the electrochromic medium comprises a cathodic material, an anodic material, and at least one solvent.

2. The electro-optic element of claim 1, wherein the first substantially transparent polymer substrate is characterized by at least one of:
a thickness that provides a surface stress of less than about 4×10⁴ psi, as measured on a 1 inch long and 0.1 inch wide sample with a 0.01 psi applied force; and
a deflection of less than about 8 inches under a 0.01 psi applied force, as measured on a 1 inch long and a 0.1 inch wide sample, at least one of prior to or subsequent to disposing the first polymer multi-layer film on the first substantially transparent polymer substrate.

3. The electro-optic element of claim 1, further comprising:
a third substrate one of coupled with or laminated to the first substantially transparent polymer substrate,
wherein the third substrate is characterized by a higher rigidity than a rigidity of the first substantially transparent substrate.

4. The electro-optic element of claim 1, wherein at least one of the first substantially transparent polymer substrate and the second substantially transparent polymer substrate comprises at least one of polyethylene, low density polyethylene, high density polyethylene, polyethylene naphthalate (PEN), polyacrylonitrile, polyethylene terephthalate (PET), heat-stabilized PET, polycarbonate, polysulfone, poly(methyl methacrylate) (PMMA)), polyimides, a cyclic olefin polymer (COP), a cyclic olefin co-polymer (COC), an acrylic, a polyamide, a cycloaliphatic diamine dodecanedioic acid polymer, an epoxy, polymethylpentene, cellulose ester-based plastics, cellulose triacetate, a transparent fluoropolymer, polyacrylonitrile, and a combination thereof.

5. The electro-optic element of claim 1, wherein at least one of the first and second substantially transparent polymer substrates comprise a Young's Modulus of about 3×10⁵ psi to about 8×10⁵ psi.

6. The electro-optic element of claim 1, wherein:
at least one of the first polymer layer and the second polymer layer comprises at least one of an acrylic polymer, a siloxane-based polymer, a polyethylene terephthalate (PET) polymer, a polyester polymer, poly(methyl methacrylate) (PMMA), a polycarbonate (PC) polymer, and a combination thereof; and
the inorganic layer comprises at least one of silicon oxide, silicon nitride, zinc tin oxide, aluminum oxide, tin oxide, hafnium oxide, and combinations thereof.

7. The electro-optic element of claim 1, further comprising:
a second polymer multi-layer film disposed between the second substantially transparent polymer substrate and the second conductive layer.

8. The electro-optic element of claim 1, wherein the first electrically conductive layer is characterized by a change in sheet resistance of less than 20% after exposure to the electrochromic medium at an electrochromic medium temperature of 45° C. for 1000 hours.

9. An electro-optic element, comprising:
a first substantially transparent polymer substrate defining first and second surfaces, wherein the second surface comprises a first electrically conductive layer;
a first hardcoat layer disposed between the first substrate and the first electrically conductive layer;
a second substantially transparent polymer substrate defining third and fourth surfaces, wherein the third surface comprises a second electrically conductive layer;
a second hardcoat layer disposed between the second substrate and the second electrically conductive layer; and
an electrochromic medium disposed in a cavity defined between the first and second substrates and comprising a cathodic material, an anodic material, and at least one solvent,
wherein the first and second electrically conductive layers are characterized by a change in sheet resistance of less than 20% after exposure to the electrochromic medium at an electrochromic medium temperature of 45° C. for 1000 hours.

10. The electro-optic element of claim 9, wherein the first and second electrically conductive layers are characterized by a change in sheet resistance of less than 20% after exposure to the electrochromic medium at an electrochromic medium temperature of greater than 45° C. to about 85° C. for 1000 hours.

11. The electro-optic element of claim 9, wherein at least one of the first and second electrically conductive layers comprises at least one of fluorine-doped tin oxide, aluminum zinc oxide (AZO), indium zinc oxide (IZO), and indium tin oxide (ITO).

12. The electro-optic element of claim 9, wherein at least one of the first hardcoat layer and the second hardcoat layer comprises at least one of an acrylic polymer, a siloxane-based polymer, a polyethylene terephthalate (PET) polymer, a polyester polymer, poly(methyl methacrylate) (PMMA), a polycarbonate (PC) polymer, and a combination thereof.

13. The electro-optic element of claim 9, wherein at least one of the first and second electrically conductive layers comprises an insulator-metal-insulator structure.

14. The electro-optic element of claim 13, wherein the insulator-metal-insulator structure comprises a silver metal, a silver metal alloy, or a doped silver layer.

15. The electro-optic element of claim 9, further comprising:
a third hardcoat layer disposed between the first hardcoat layer and the first electrically conductive layer; and
a fourth hardcoat layer disposed between the second hardcoat layer and the second electrically conductive layer.

16. The electro-optic element of claim 15, further comprising:
a first inorganic layer disposed between the first hardcoat layer and the third hardcoat layer; and
a second inorganic layer disposed between the second hardcoat layer and the fourth hardcoat layer.

17. The electro-optic element of claim 9, wherein at least one of the first and second hardcoat layers comprises a Shore D hardness of about 50 to about 100.

18. The electro-optic element of claim 9, wherein at least one of the first substantially transparent polymer substrate and the second substantially transparent polymer substrate comprises at least one of polyethylene, low density polyethylene, high density polyethylene, polyethylene naphthalate (PEN), polyacrylonitrile, polyethylene terephthalate (PET), heat-stabilized PET, polycarbonate, polysulfone, poly(methyl methacrylate) (PMMA)), polyimides, a cyclic olefin polymer (COP), a cyclic olefin co-polymer (COC), an acrylic, a polyamide, a cycloaliphatic diamine dodecanedioic acid polymer, an epoxy, polymethylpentene, cellulose ester-based plastics, cellulose triacetate, a transparent fluoropolymer, polyacrylonitrile, and a combination thereof.

19. The electro-optic element of claim 9, wherein at least one of the first and second substantially transparent polymer substrates comprises at least one of:
a thickness that provides a surface stress of less than about 4×10⁴ psi, as measured on a 1 inch long and 0.1 inch wide sample with a 0.01 psi applied force; and
a deflection of less than about 8 inches under a 0.01 psi, as measured on a 1 inch long and a 0.1 inch wide sample, at least one of prior to or subsequent to disposing one of the first and second hardcoat layers on the respective one of the first and second substantially transparent polymer substrates.

20. The electro-optic element of claim 9, further comprising at least one of:
a third substrate one of coupled with or laminated to the first substantially transparent polymer substrate, wherein the third substrate is characterized by a higher rigidity than a rigidity of the first substantially transparent substrate; and
a fourth substrate one of coupled with or laminated to the second substantially transparent polymer substrate, wherein the fourth substrate is characterized by a higher rigidity than a rigidity of the second substantially transparent substrate.
